(19) United States
(12) Patent Application Publication
(10) Pub. No.: US 2009/0203352 A1
(43) Pub. Date: Aug. 13, 2009

(54) MOBILE PHONE/DEVICE USAGE TRACKING SYSTEM AND METHOD

(75) Inventors: Robert W. Fordon, Farmington, NY (US); Douglas J. Montevecchio, Victor, NY (US); Timothy A. Montevecchio, Penfield, NY (US)

Correspondence Address: BASCH & NICKERSON LLP, 1777 PENFIELD ROAD, PENFIELD, NY, 14526, US

(73) Assignee: Xelex Technologies Inc., East Rochester, NY (US)

(21) Appl. No.: 12/369,393

(22) Filed: Feb. 11, 2009

Related U.S. Application Data
(60) Provisional application No. 61/028,376, filed on Feb. 13, 2008.
(60) Provisional application No. 61/079,882, filed on Jul. 11, 2008.

(51) Int. Cl. H04M 11/00

(52) U.S. Cl. 455/406

(57) ABSTRACT

Disclosed are systems and methods that enable organizations, for example corporations and legal firms, to manage mobile communication devices and device usage, and to automatically and remotely apply or link that usage to particular departments and/or clients.

This application is related to and claims priority from the disclosures, including appendices, found in prior Provisional Application Nos. U.S. 61/079,882 by Robert W. Fordon, Douglas J. Montevecchio and Timothy A. Montevecchio, filed Jul. 11, 2008 for a “MOBILE PHONE/DEVICE USAGE TRACKING SYSTEM AND METHOD; and U.S. 61/028,376 by Robert W. Fordon, Douglas J. Montevecchio and Timothy A. Montevecchio, filed Feb. 13, 2008 for a “MOBILE PHONE/DEVICE USAGE TRACKING SYSTEM AND METHOD,” both provisional applications being hereby incorporated by reference in their entirety.

As used herein, MobileTrack™ is a software system and associated methodology that enables organizations such as corporations, legal firms and service providers to manage mobile devices and device usage, and automatically apply or link that usage to particular departments and/or clients. MobileTrack can reside on all of an organization's mobile phones and other mobile communication/computing devices (e.g., PDA's such as Palm Treo™, Blackberry™, iPhone™ and the like) and may be used to monitor all activity without any interaction with the service provider. Records reflecting this activity are sent to a central collector for rating and allocation. The following disclosure gives an overview of the MobileTrack product, system components and the methods employed therein, including the features and functions thereof, as well as several applications describing uses of the disclosed systems and methods.

### COMPUTER SOFTWARE APPENDIX

A computer program listing Appendix is included and hereby incorporated-by-reference in the instant application. The Appendix includes 5 files concurrently filed herewith as follows:

| Filename | Size | Date | Description |
|---|---|---|---|
| DeviceAppCode.txt | 321 KB | Feb. 11, 2009 | Device application code, including |
| | | | various event monitors |
| EventPrcssrSrc.txt | 108 KB | Feb. 12, 2008 | Event Processor for Mobile Monitor |
| RatingClientServerSrc.txt | 786 KB | Feb. 12, 2008 | Rating Engine (client-server) |
| | | | source code |
| symphonyCRM.txt | 1545 KB | Feb. 11, 2009 | C# Program code for Symphony |
| | | | web |
| symphonyCRMASPX.txt | 1296 KB | Feb. 11, 2009 | HTML code for Symphony web |

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND AND SUMMARY

For some time now, companies and other organizations have been expanding use of and reliance upon mobile communications devices such as computers/processors, hand-held devices, telephones, etc. As the use of mobile communications technologies expands, particularly for corporate and organizational users, there is a similar increase in demand for systems and methods capable of tracking and managing such devices. For example, it may be important in many organizations to: (i) be able to distinguish business versus private usage, (ii) be able to determine which clients are being contacted/supported by such use and thereby allocate some or all of the cost of the mobile device across the client(s) being supported, (iii) track usage and data for voice, messaging, web browsing, etc., (iv) track current and/or usage locations for mobile devices, and (v) provide for, or control, mobile devices via over-the-air provisioning, etc.

Other features enabled by the embodiments disclosed herein include data backup, transfer of data from one device to another, as well as installation of applications. The systems and methods may also be used to further control usage of the devices, including limiting time or amount (cost) of usage. It is further contemplated that the system may send notifications when such time or cost/credit limits are approached (e.g., notification when 80% of available time or credit is used). As will be described in more detail below, the system may also be employed to collect and summarize usage in relation to account codes or similar designations, including applying usage and/or costs to particular clients or customers based upon such account codes. Furthermore, embodiments of the system may also include links and interfaces (e.g., API's) that permit the information collected, monitored and/or tracked by the system to be accessed by or shared with other independently developed software programs and systems.

While aspects of such tracking may be available on a user subscription basis, where a user can review to his/her usage of airtime minutes, messages and bytes transferred for browsing, a solution for tracking such usage and automatically reporting it to a central location for further processing and use by the organization is not believed to be known. This information is available in real-time to a device user, and to the corporate or organizational “manager,” thereby avoiding the need to connect to a central server or Internet browser to view usage. Moreover, such a system can be independently configured and administered by an organization—thereby allowing for customization with the addition of client/customer codes and the like.

Some examples of organizations that may employ the MobileTrack™ are: (i) Telecom management software providers; (ii) Service providers (e.g., telephone companies, utilities); (iii) Cell phone rental agencies; (iv) law, accounting and consulting firms; and (v) Enterprise companies. Telecom management software providers are companies that supply call accounting and facilities management solutions to large enterprise companies such as Paetec Software, Veramark Technologies, MTS and Acecom. Service providers include companies such as Verizon, AT&T as well as government owned companies in the Caribbean and Europe. Cell phone rental agencies offer phones for finite periods of time and bill the customer for all usage and rental charges at the end of the rental period. These are companies such as car rental agencies, WorldCell and Gcellular. Large law, accounting and consulting firms need to charge their time to clients and projects and MobileTrack offers time allocation through account code assignment. Some of these companies include Cap Gemini and Price Waterhouse. Enterprise Companies are, for example, large corporations and government agencies that need to account for, control and manage cell phone usage. In one alternative, referred to as FamilyTrack™, aspects of the disclosed embodiments may be employed to track and control phones and related devices of a family group.

Further embodiments and applications are contemplated as a result of the real-time, or near real-time exchange of data with such mobile devices, particularly when location services and/or location information are included. In one embodiment described below, a GPS-enabled device regularly records the device location for later use. Uses include, for example, reporting a last-known position with each call, message, or other data exchange completed via the device, or even tracking of the mobile device. The use of such location services also facilitates additional functionality and/or interaction with such as applications including BreadCrumbz™ (a navigation tool), City Slikkers™ (a location-based game), PedNav™ (a daily activities planner tied to the urban environment), Locale™ (a location- and time-based user profiling application) and LifeAware™ (a family and friends tracking service). Other applications may include social networking such as Beetaun^{SM} (a social networking service based on geographical content), Sustain™ and Pocket Journey™ (which promises connections to a global community of artists, historians, architects, musicians and comedians).

Location services further permit targeted (location-specific) weather information, forecasts, warnings and the like. The availability of real-time location tracking features as described below also permit the delivery and interface to applications such as Em-Radar™ which delivers emergency and severe weather alerts, HandWX™ offers seven-day weather forecasts. For example, one embodiment contemplates a Storm Warning advisory service that delivers announcements based on GPS location reported via the real-time exchange of data from a mobile device. Further contemplated are Tornado warnings that could direct people to move in appropriate directions when comparing the storm locale to the phone coordinates.

Consider, for example, a situation where a user signs up for a new service at his/her home (e.g., requests the water company to initiate service in an apartment being rented). At a later time, on the day the new service is activated, the user is sent, and receives, an SMS welcoming them to the water company. This may seem to be a great customer service tool, however, perhaps at the time the message is received the user is in a business meeting on the other side of the country or world—wherein the SMS message is merely an annoyance. Using the present system, such messages could be stored or delayed for a time until the user returns to a geographic region closer in proximity to his/her apartment, when the message may be more appropriate, and perhaps better received by the user.

The various embodiments described herein independently or collectively provide a variety of tracking and monitoring functions and information, either themselves or in conjunction with related software and systems. Such information is occasionally referred to as “platinum data,” as it pertains to and enables the gathering of valuable information. It is contemplated that tracking and monitoring may include:
Devices
User ID's—a device may have several users each with a different profile
Button sequences and feature keys
Display history—verify what the user likely saw
Applications—assume full multiple media
   Application use if populated with API's to track
Operating Systems
Browsers used
Networks servicing a device.
Device stored information
Transactions, including calls, websites visited, SMS data (e.g msg), call accounting data (e.g., CDR), etc.
Events
Power
Signal strength
Location—Latitude/Longitude
   Altitude, speed heading
Presence
State(s)
Service requests, diagnostics, update alerts
Application utilities like compression, players, flash etc.
Rebroadcasts
Network interruptions
Phone number—dialed/received
Browser bypass
Terminal performance
Control Usage
Credit Watch
Speed of Device Movement
Data Usage—sent/received

Disclosed in embodiments herein is a system for tracking usage of a mobile communication device, comprising: a programmable processor associated with the communication device for collecting data associated with usage of the communication device; a device memory for storing a call (usage) detail record associated with such activity; transmission means for sending the call detail record to a mobile collector, said mobile collector receiving call detail records from a plurality of mobile communication devices; and a corporate server for receiving processed usage data from said mobile collector and associating said usage data with one or more accounts (clients/customers, users, cost centers, departments, etc.).

Further disclosed in embodiments herein is a communication usage and expense tracking system or method, comprising: a plurality of mobile communication devices, each including a programmable processor for collecting data associated with usage of the communication device, and device memory for storing a call (usage) detail record associated with such activity; communication means (e.g., sms, ftp, e-mail, http, command/response) for transmitting the call detail record(s) from each device to a mobile collector, said mobile collector receiving call detail records from the plurality of mobile communication devices; and a database (e.g., Symphony Mobile Database) for receiving and storing call detail records and processed usage data from said mobile collector and associating said usage data with one or more accounts.

### BRIEF DESCRIPTION OF THE DRAWINGS

FIG. 1 is a block diagram providing an overview of an exemplary embodiment (MobileTrack™) of the disclosed system and method;

FIG. 2 is an illustration of an exemplary provisioning dialog window that would appear in a Windows-based device;

FIG. 3 is a block diagram illustrating the various components and functions of a mobile collector in accordance with the embodiment of FIG. 1;

FIGS. 4-6 are exemplary screen shots illustrating various features and functions of the disclosed embodiments;

FIGS. 7-9 are exemplary illustrations created using a software development system depicting the various classes and software modules used in an embodiment of the system;

FIG. 10 is a general representation of an application platform (Symphony) that may be employed in accordance with the disclosed embodiments;

FIGS. 11A-G represent a flowchart depicting the operation of a rating server in accordance with one aspect of the disclosed system;

FIGS. 12A-I represent a rating database as employed to enable the functionality depicted in the flowchart of FIGS. 11A-G;

FIG. 13 is an exemplary flowchart depicting steps completed by an event processor in accordance with an aspect of the disclosed system;

FIG. 14 is an illustration of the code organization for the event processor;

FIGS. 15-18 are illustrative example of data dictionaries employed to store information for the rating process described relative to FIG. 11;

FIGS. 19 and 20 are exemplary user interface screens illustrating some functions of the system;

FIGS. 21A-C are exemplary illustrations of a use that may be made of data collected via the system;

FIGS. 22 and 23A-B are illustrative examples of user interfaces related to over-the-air features that are facilitated by the system; and

FIG. 24 is an illustrative example of an alarm feature employed in one of the embodiments disclosed.

The various embodiments described herein are not intended to limit the invention to those embodiments described. On the contrary, the intent is to cover all alternatives, modifications, and equivalents as may be included within the spirit and scope of the invention as defined by the appended claims.

### DETAILED DESCRIPTION

As more particularly set forth below, the disclosed system and methods enable companies, organizations, etc. to manage their employee's and agent's mobile devices and device usage, and to apply or link that usage to particular departments and/or clients for billing, usage and/or performance tracking purposes. The term applied to the system and methods disclosed herein is MobileTrack™ and the software for implementation on portable communications devices may be installed on some or all of an organization's mobile phones and other mobile communication devices. The software then controls the creation of records reflecting this activity, and the sending or uploading of the record data to a central collector for rating and allocation as will be described in more detail below.

The following terms and acronyms have been employed in the disclosure:
Alarm A notification that there is a malfunction or an error condition has occurred.
CDR Call Detail Record and also the event detail record (includes various events, not limited to calls), is used to indicate data associated with a call or event at the communication device.
Database As the term is used herein it includes various configurations that provide a repository for data; which may include standard programmatic functions enabled via SQL and other known database types, as well as alternative data configurations.
Direction Indicates whether the event is incoming or outgoing. This is not used for data events, bytes sent and bytes received are used.
Event Type This reflects the type of transaction the phone generated such as Type a Mobile Originated Call (MOC), Short Message (SMS), Mobile Terminated Call (MTC), standard voice call, data, etc. (see following table).
MOC Mobile Originated Call.

MTC Mobile Terminated Call.

OTA The term over-the-air (OTA) provisioning describes the ability to download and install content over a wireless network, typically on demand, as well as control of one or more features of the mobile device.
Rating The process costing a CDR based on Service Plan, Event Type, Direction, Time of Day and Destination number.
Roaming The mobile subscriber is not on his/her home network and is considered Roaming. Call rates usually increase when roaming.
Service Plan Specifies the rates for all mobile events including free minutes. Plan
SMS Short Message Service.

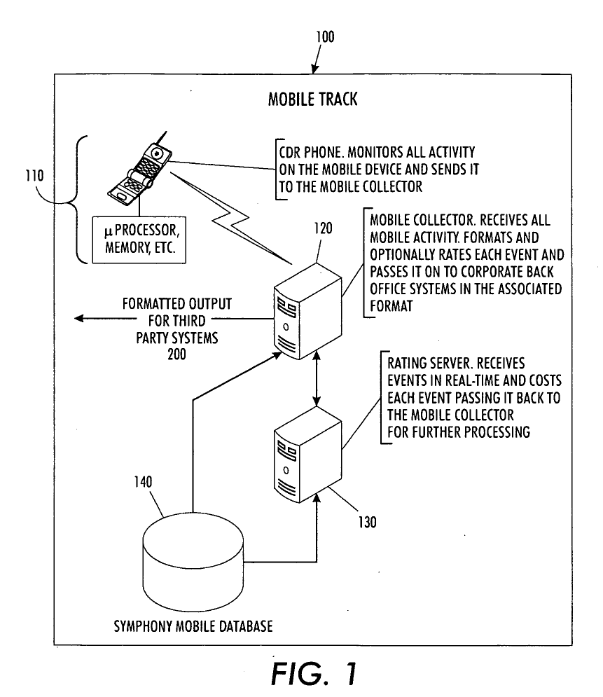

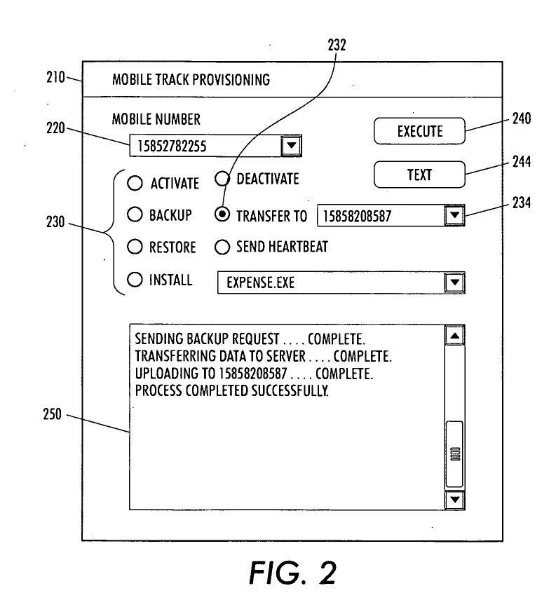

Referring now to FIG. 1, depicted therein is a general block diagram presenting an overview of an exemplary MobileTrack™ embodiment. As noted above, the MobileTrack system 100 may be employed to track usage of a mobile communication device 110 such as a cellular or similar mobile phone. Although described relative to a mobile phone as an example of the communication device, it should be further appreciated that the methods disclosed herein may be applicable to a number of alternative communication and digital devices, including, but not limited to, iPhones, Blackberrys, Treo's, smart-phones, as well as conventional cellular, digital and satellite phones and other mobile communication devices. Each of such devices includes a programmable processor (e.g., a micro-processor) associated with the communication device for controlling the collection, storage and transmission of data associated with usage of the communication device, and an associated device memory for storing a call detail record associated with such activity. A call or event detail record may include information such as the following:

| Name | Description | |
|---|---|---|
| Start Time | Date and time the event (e.g., call, message) was initiated | |
| End Time | The date and time the event ended. | |
| Event Type | VOICE, SMS, DATA or MMS | |
| | VOICE | A standard voice call. The user either initiated the call or |
| | | received the call. The direction indicator will identify the |
| | | voice call's origination. |
| | SMS | The user either sent an SMS or received one. The |
| | | direction indicator will identify the SMS's origination. |
| | DATA | The user initiated a data transaction such as web |
| | | browsing, uploading or downloading files. The data |
| | | usage Received and Sent fields will contain the number |
| | | of bytes sent and received during this event. |
| | MMS | The user initiated a Multi-media transaction such as |
| | | watching a movie or video clip. The data usage Received |
| | | and Sent fields will contain the number of bytes sent and |
| | | received during this event. |
| | OTHER | Future communication events not presently enabled. |

| | |
|---|---|
| Direction | This field denotes the direction of the incoming and\or |
| | outgoing events. For VOICE it is either a Mobile Originated |
| | Call (MOC) outgoing or Mobile Terminated Call (MTC) |
| | incoming. |
| Duration | The length of the event in number of seconds. |
| Data Usage | The number of bytes received during the event. |
| Received | |
| Data Usage | The number of bytes sent during the event |
| Sent | |
| Network | The network the user was on during the event. This is either |
| | HOME (user is on his/her home network) or ROAM the user |
| | is roaming on a third party network. |
| Local Number | The telephone number of the user's mobile device. |
| Third Party | The telephone number of the destination or the originating |
| Number | phone number for SMS and VOICE events. |
| Account Code | The associated client account code. This is an optional field |
| | and is used only when the account code option is turned on |
| | within the device (see FIG. 2). |

The phone 110 sends an activity record (in real-time and/or batch) for every event (call, message, data transfer (e-mail, web-browsing, etc.) that takes place on the mobile device. In an alternative embodiment as discussed below, the phone or device 110 may also send other information, for example, location data (e.g., periodic locations, last-known location, etc.) As represented by the “Account Code” field in the table above, in one embodiment the CDR Phone can automatically assign account codes to the activity for charging of clients (used by law and consulting firms). The user can maintain a list of telephone numbers and account codes on the mobile device. If a match on the telephone number to the event's Other Party Number occurs, the account code will be automatically added to the activity record. If no match is found the user may be prompted to enter an account code through a user-interface display (e.g., dialog box or the like), and an account code can then be manually entered.

In real-time mode, after each event is completed the phone 110 transmits the activity data such as the call detail record, or a similar data schema, to the mobile collector 120. In a batch mode, or when connectivity has been re-established, the activity data would periodically be sent to the mobile collector. If the transmission is unsuccessful, as determined by failure to receive an acknowledgement of successful transmission, the phone (micro-processor) will retry to send the data at user-defined intervals until it successfully transmits the activity record.

The CDR device may also respond to “heartbeat” requests. Heartbeat requests are requests sent to the device from the mobile collector asking if the device is functioning. Usually a heartbeat request is sent to the mobile device when the mobile collector has received no activity from the mobile device in a user-specified period of time. For example, when the mobile monitor has not received any activity in three hours, three days, etc., it will send a heartbeat request to the mobile device. The mobile device will respond to the heartbeat request via SMS, FTP or WEB service to acknowledge to the mobile monitor that all is well. Such a response may also include a current or last good GPS location.

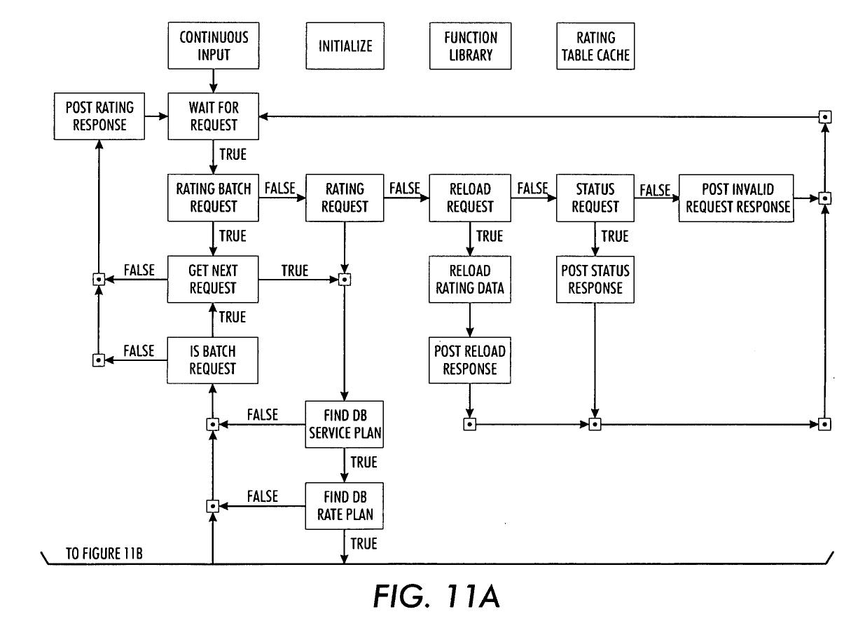

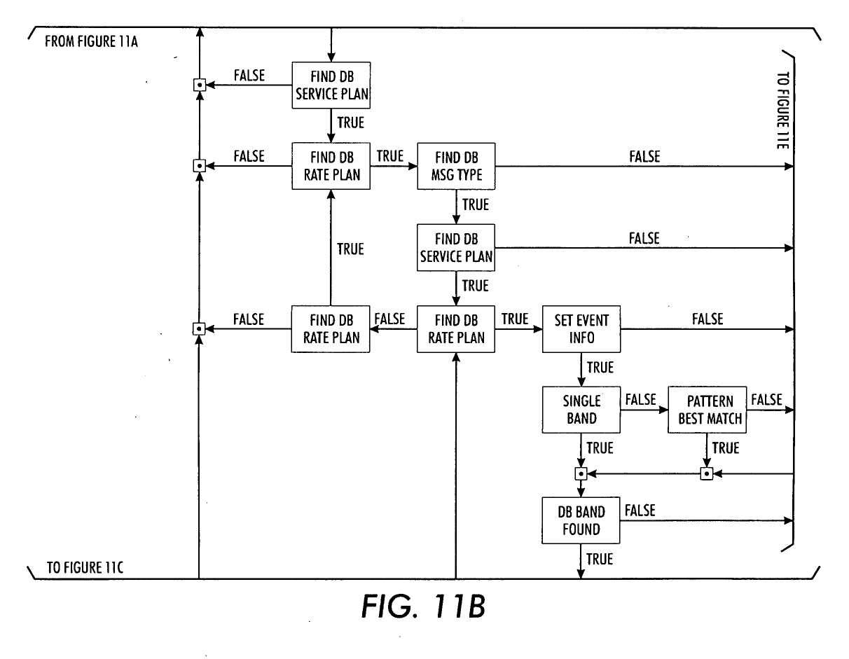

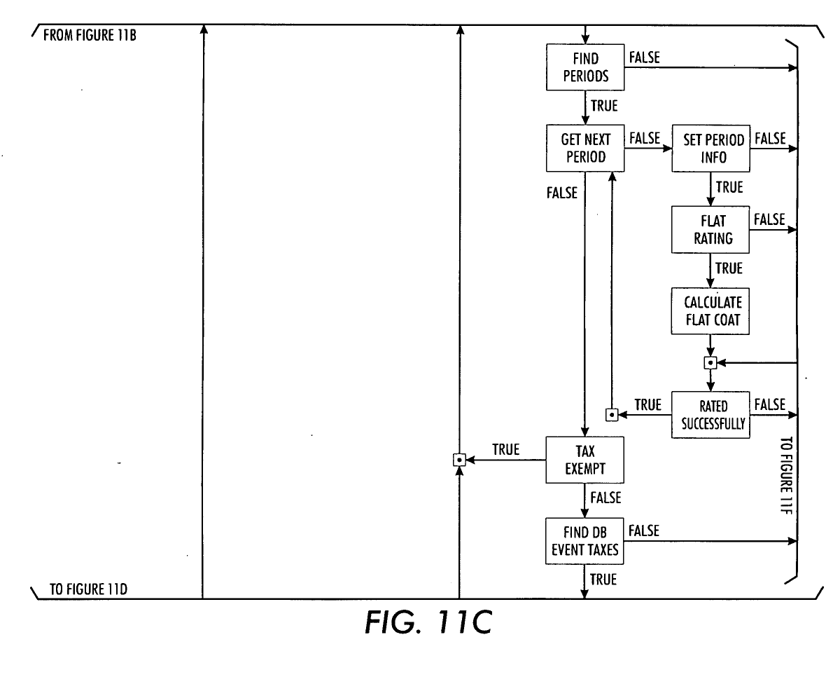

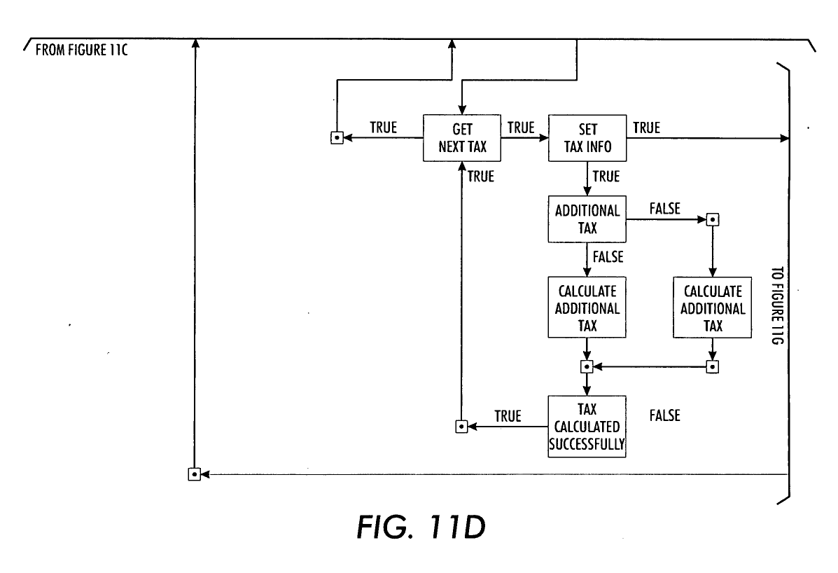

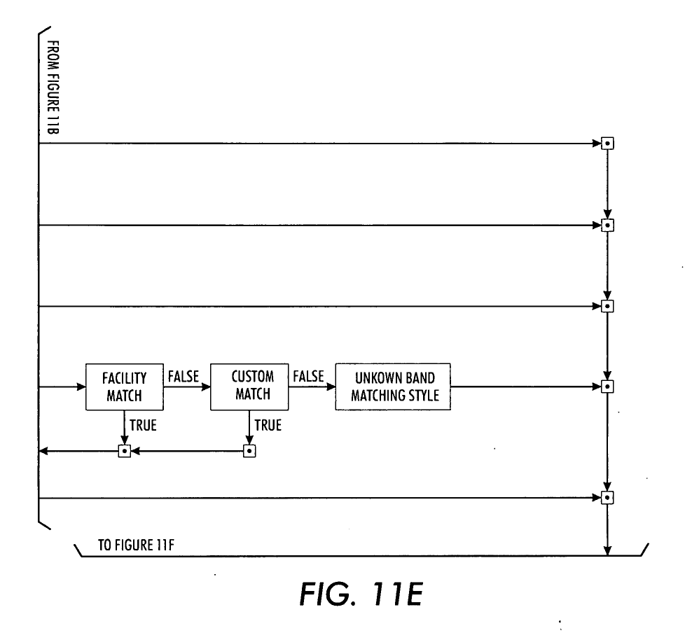

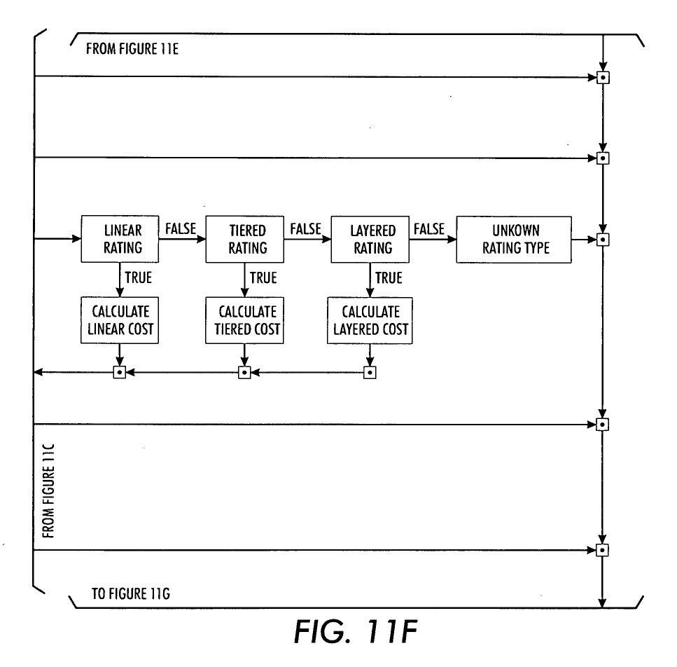

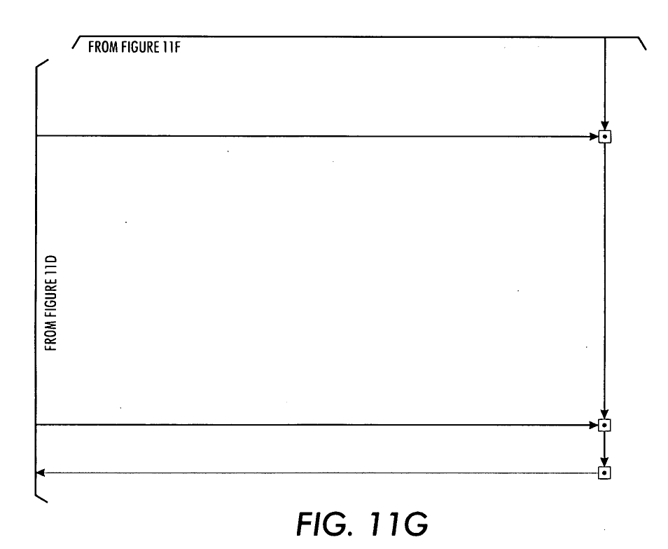

As further illustrated in FIG. 1, the system may also include a rating server 130 for providing real-time cost data to the mobile collector in response to activity data such as a call record. Operation of an exemplary rating service is represented by the flowchart of FIGS. 11A-G as is generally described below. The rating server information may be used by the mobile collector, in conjunction with the call detail record, to rate the CDR's or events. Rating includes calculating or determining the various costs associated with a particular call or communication (e.g., toll portion, airtime portion, applicable taxes on each, etc.). The rating server may also provide input to permit tracking of credit limits on the usage of the device.

In one embodiment, the rating information may further include discounts, free minutes, calling plans (e.g., friends-and-family, call circles, closed user groups, etc.) and related information. Another information component(s) that may be included with the CDR are quality-of-service (QOS) metrics, which may be combined with rating information. Availability of the rating information may also permit the user of the phone or device to estimate or predict the cost of a communication. For example, a user may ask, “how much will it cost to make a 3-minute call to Germany?” Such functionality may require the addition of one or more fields, or additional information within an already-defined field, within the call detail record. Alternatively, the cost estimate function may be enabled via a separate server and a web-based interface.

The database 140 illustrated in FIG. 1 is employed to provide a repository for the call detail records and related information (e.g., cost data used by the rating server). The database may be physically part of the mobile collector or a separate system that is connected or networked with the mobile collector to assure access to the collector and the exchange of data. Although shown as a single database, it will be appreciated that a plurality of databases may be employed, each storing respective information.

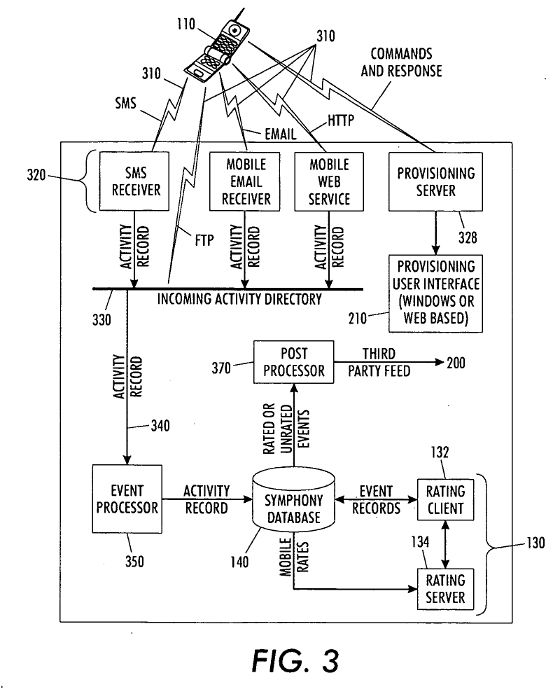

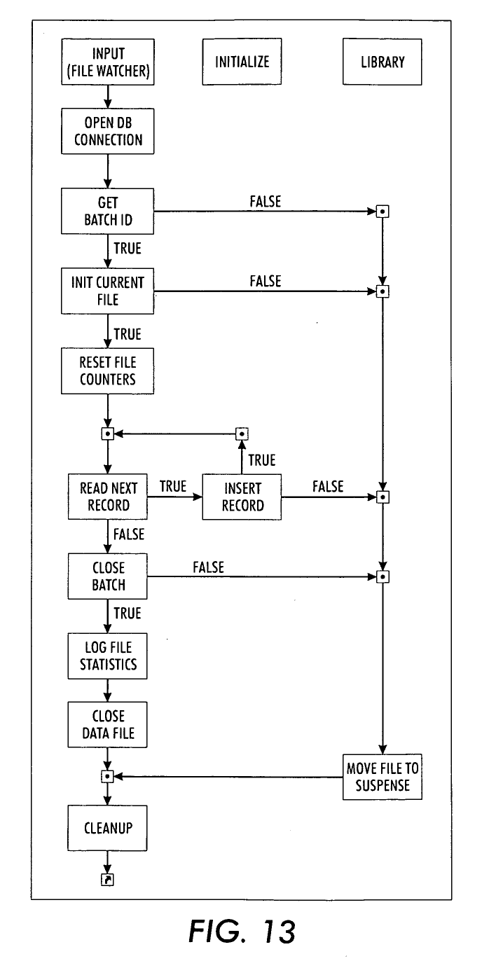

As will be appreciated, and as depicted in FIG. 3, various communication channels 310 (SMS, ftp, http, e-mail and proprietary command/response sequences) may be employed to facilitate communications between the device or phone 110 and the mobile collector 120 of FIG. 1. These channels, or transmission means, include the channels that are available to the device, and while largely wireless, are not necessarily limited to cellular transmission channels as it may be possible to collect and transfer data to the mobile collector using Wi-Fi as well as shorter range techniques such as infrared and Bluetooth™ communication channels available on many mobile devices today. Thus, one of the available transmission means would be used for sending the call detail record or data to the mobile collector. Referring to FIG. 3, the mobile collector receives call detail records from the mobile communication devices via one of a plurality of receivers or services 320. Once received, the records or data are stored in an incoming activity directory, where the records are then selected for processing by event processor 340. Event processor 350, for which source code is found in EventPrcssrSrc.txt file in the Appendix, operates to parse CDR files and insert the corresponding records into the database as described in more detail relative to FIG. 13. It should be further appreciated that, as noted in the terms set forth above, CDR data, also referred to as call or usage data, may include any of the various types of information pertaining to the use of the phone/device as described herein and including call information, messaging information, web browsing, etc.

Returning to FIG. 2, depicted therein is an exemplary provisioning dialog box or window that would appear in a Windows-based workstation to enable provisioning. A similar interface would be used in a web-based embodiment. As utilized herein, the term “provisioning” includes the control of operation of the device such as operability, access to features, etc. The phone 110 can be provisioned via OTA (Over the Air) technologies such that the phone or device can be deactivated and activated remotely. This gives the user a central point for managing all mobile devices. Examples of the functionality (provisioning exchanges) of the provisioning feature include:

Deactivate a mobile device;

Activate a deactivated mobile device;

Install and/or update software applications;

Back-up and restore mobile data;

Transfer mobile data from one device to another; and

Initiating a response with current location (part of heartbeat).

Provisioning commands are sent to the mobile device via SMS or wireless application protocol (WAP) interface or other standards based upon the device manufacturer. As depicted in FIG. 2, the window 210 permits the control of various functions resident on the communications device. Window 210 would be employed, for example as a pop-up window from a device administration interface running on the mobile collector 120, particularly provisioning server 328 as depicted in FIG. 3. Once activated, window 210 permits entry (or pull-down menu selection) of the phone number or other identifier for the device in field 220. When the device is selected, the window would update to depict its current or most recently selected provisions. In the example illustrated in FIG. 2, the mobile device with the number “5852782255” is to have its data transferred to the device identified by the number “15858208587” as indicated by radio button 232 and field 234. Again, field 234 may be filled in by a user or it may be selected from a drop-down menu (not shown). It will be appreciated that the data to populate the drop-down menu selections may come from database 140 as depicted in FIGS. 1 and 3. Moreover, for large organizations, a plurality of drop-down menus may be employed to first select a department, then user device identifiers (e.g., phone numbers).

Once a selection is made within the various provision features 230, the provisioning is executed by the user selecting the execute button 240. In response to execution of any particular provisioning feature, the status display 250 will be updated to depict the completion of one or more associated processes. For example, window 250 indicates that a prior backup request was initiated, and was completed successfully. Also depicted in window 210 is the install feature. This feature, in addition to an associated radio button for selection, includes a text field where the filename of the application to be installed can be inserted or selected through commonly-known browsing feature and a related window.

Referring, once again, to the block diagram of FIG. 3, the various functions and features of the mobile collector 120 of FIG. 1, including the provisioning features just described, may be accomplished under the programmatic control of a server or similar computing platform such as a standard computing device or workstation using known processors having associated memory and media, and preferably Microsoft® Windows compliant. The platform, in one embodiment operates a Microsoft® Windows™ Server or other .NET-capable operating system and includes the capability to send and receive data over a network or similar channel(s) in order to exchange information via the services 320. In one embodiment, the mobile collector includes an event processor 350 and/or post processor 370 for receiving processed usage data and associating the usage data with one or more accounts (clients/customers, users, cost centers, departments, etc.).

Having described an example of a hardware platform suitable for the system of FIG. 3, attention is turned to describing the functionality of the various components of the system. As noted above, the receiver 320 receives mobile device activity data in multiple ways, including FTP transfer, Web Service, SMS or e-mail. The receiver passes the data onto the event processor 350 via an incoming activity directory 330. Although various hardware and software configurations may be employed to implement the receiver operations, one embodiment uses the same hardware and software configuration as noted above. Depending upon the protocol for the communication channel, the receiver operates via an interface to existing Windows-based technologies to obtain the incoming data.

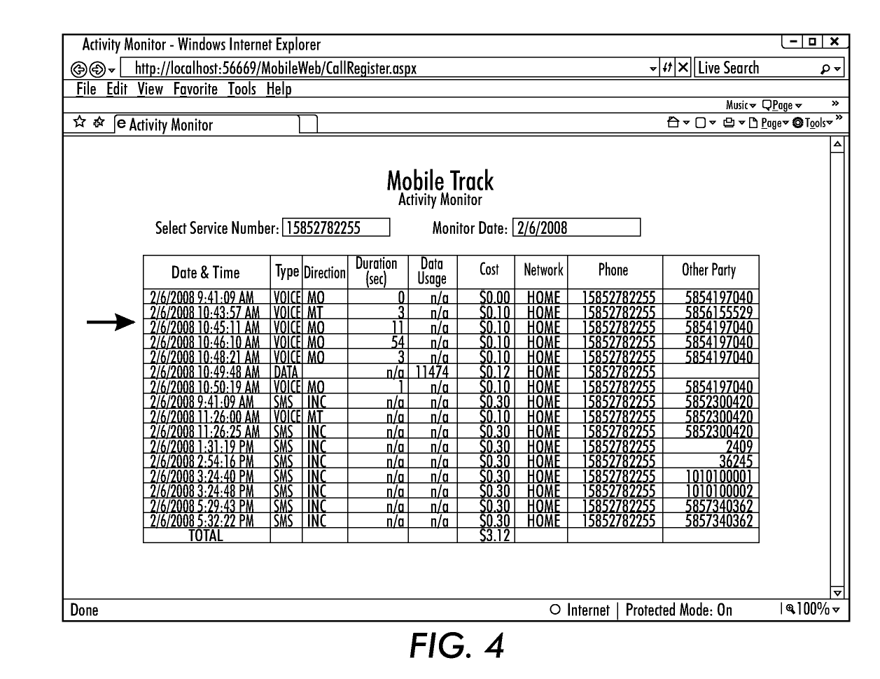

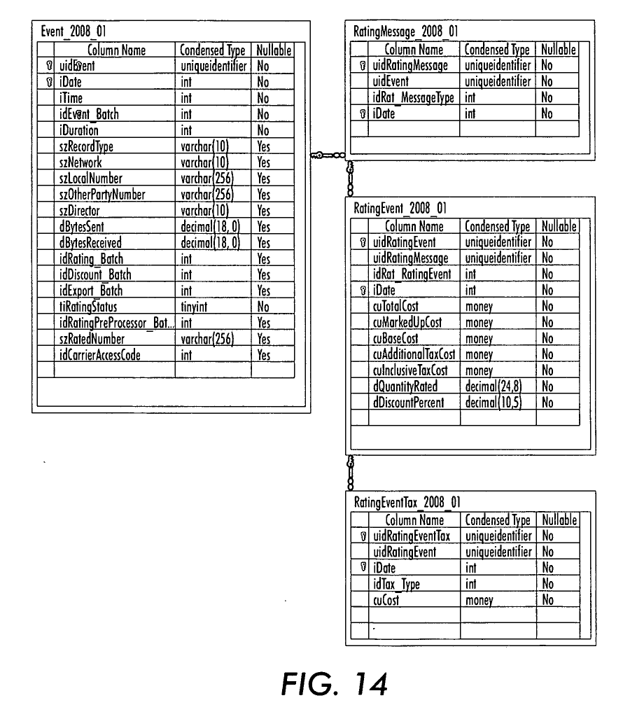

Turning to the event processor 350, this process monitors the incoming activity directory and decrypts and validates each transaction, as well as backs-up the transaction. Operating in accordance with the flowchart depicted in FIGS. 13-1 and 13-2, the event processor 350 processes and parses all entries found, and stores these transactions in the event table in the a database. In one embodiment, the database is a Symphony™ (Mobile) database available from Xelex Technologies, Inc. Symphony is a carrier-grade, stand-alone application platform and product suite that enables service providers to launch new applications and service offerings within the existing OSS. This flexibility allows Symphony to be configured for different applications such as Most Valued Routing, Rating and Revenue Assurance. For example, the database depicted in FIG. 14, is structured to provide information that is depicted in the following Symphony event table or data dictionary. More specifically, event processor 350, the code for which is found in EventPrcssrSrc.txt in the Appendix, operates to parse CDR files and insert the corresponding records into the database. For example, upon receiving a data record such as a CDR, the system identifies it as a mobile originating call, validates the data in the record, and inserts the record into the event tables of the database. As noted in the data dictionary above, the data may then be accessed and processed, for example to create a report such as the example depicted in FIG. 4.

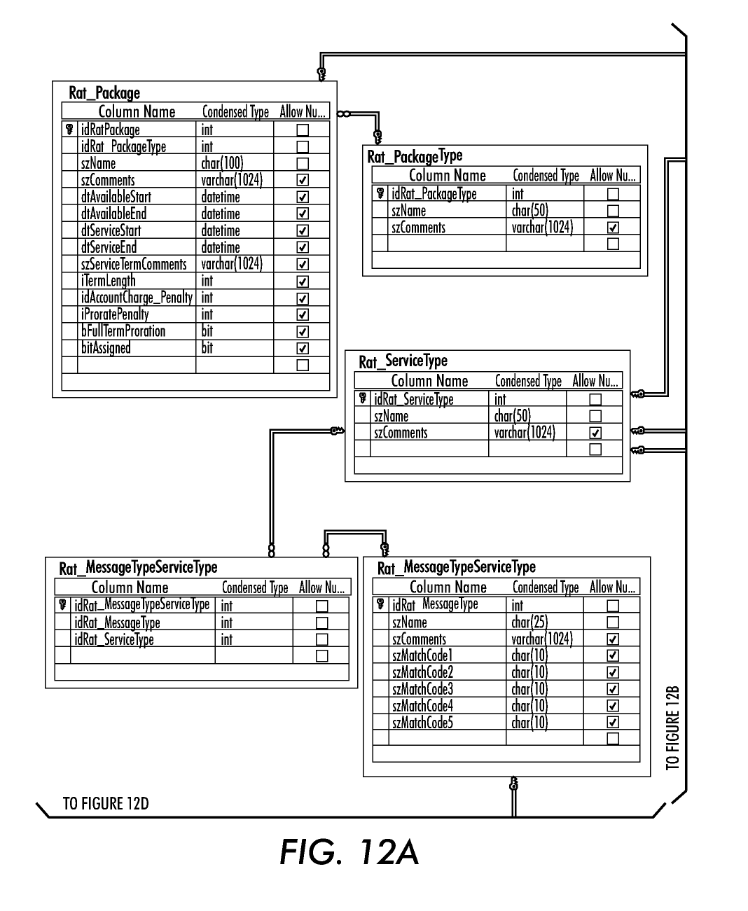

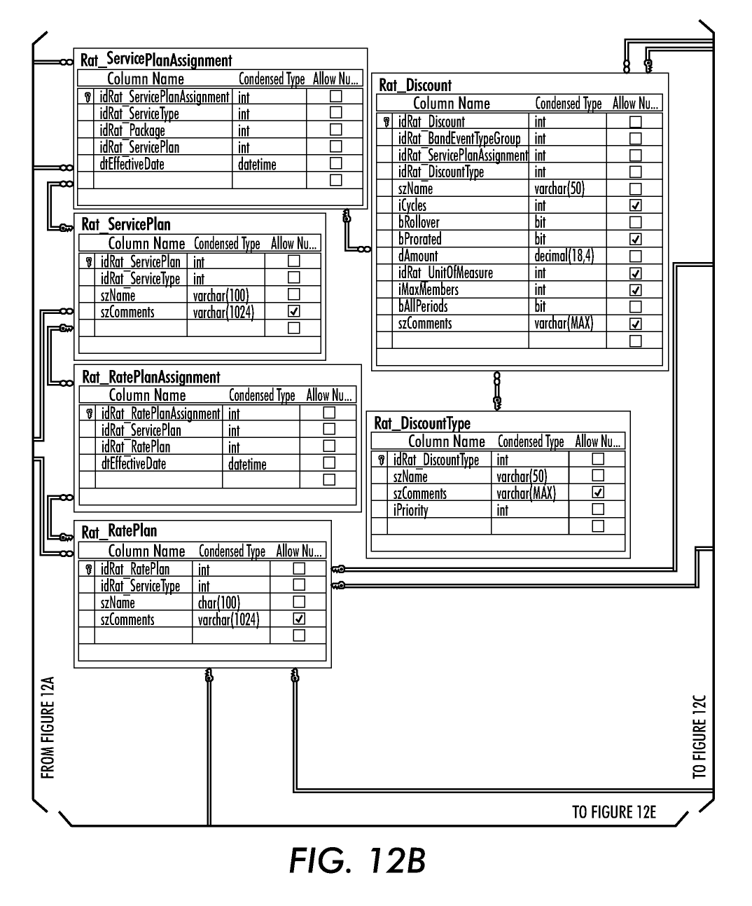

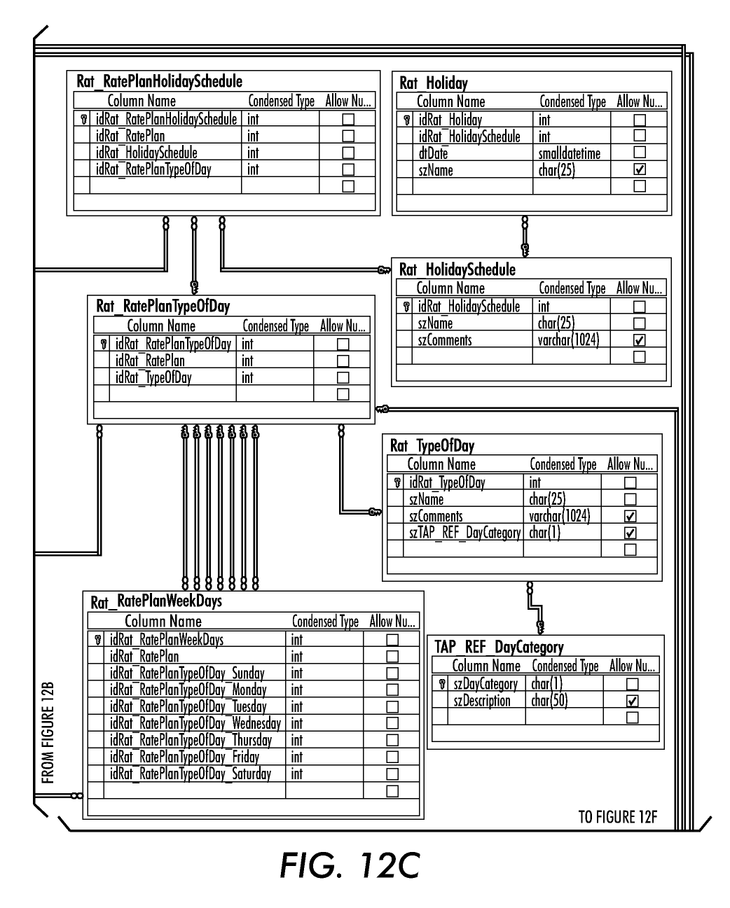

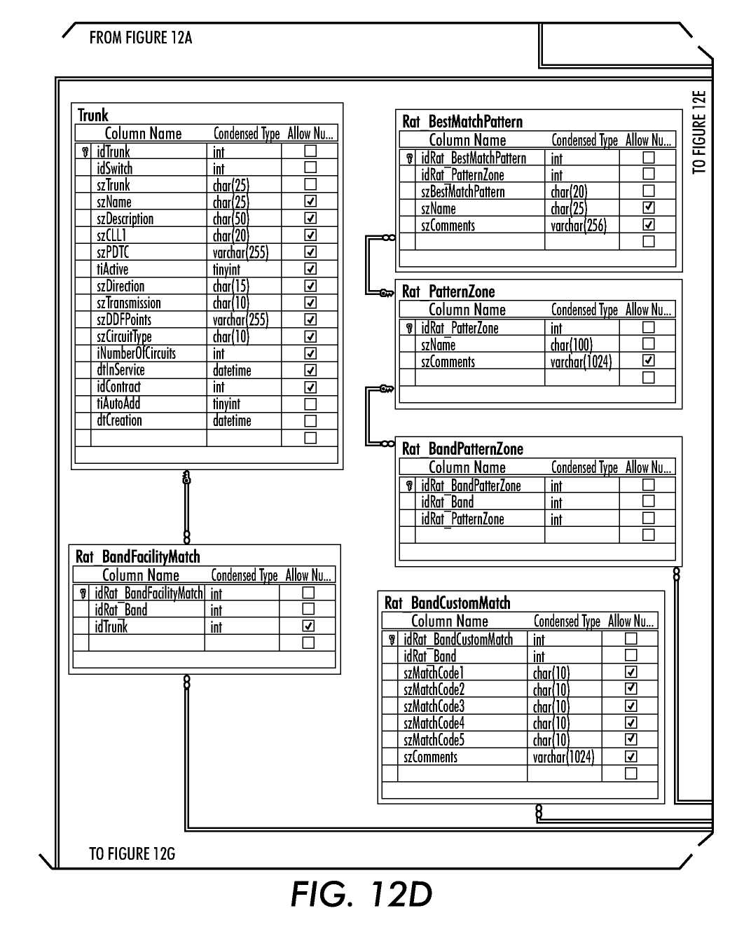

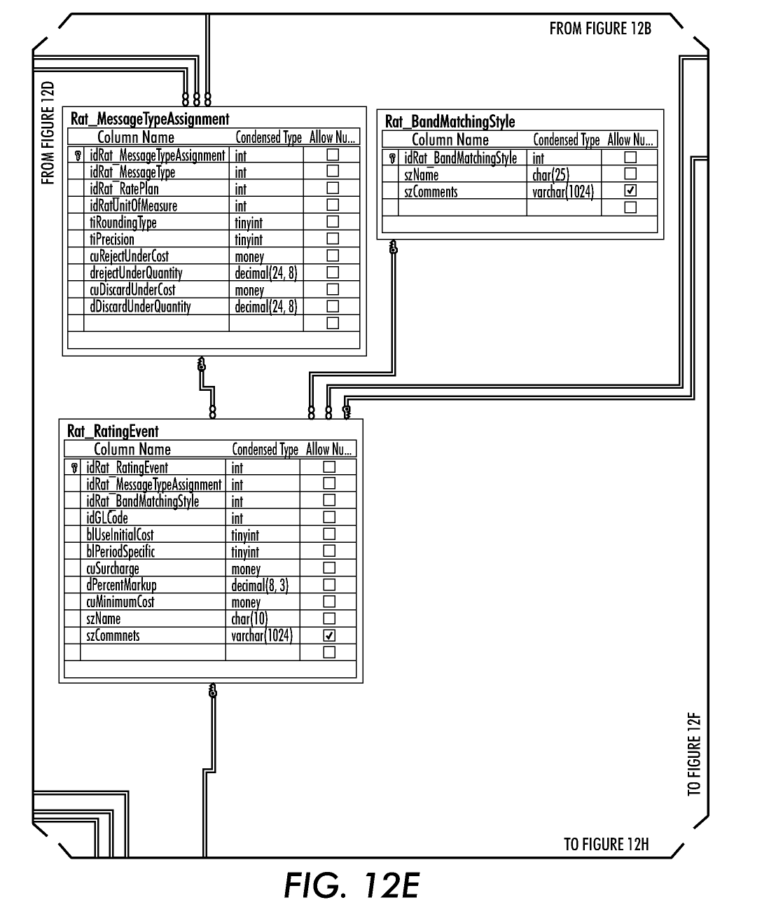

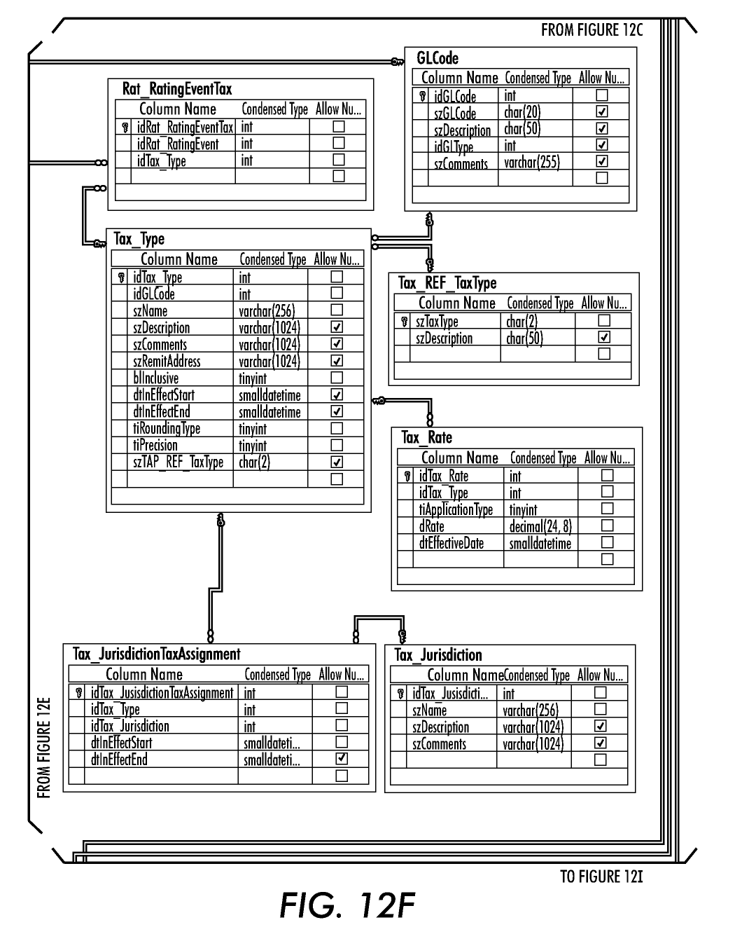

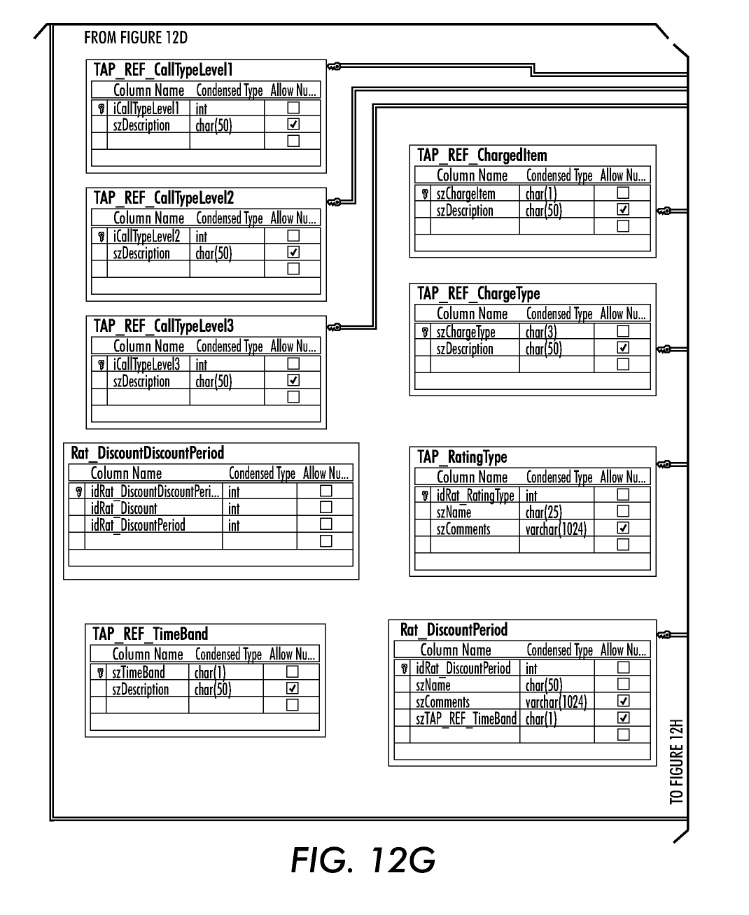

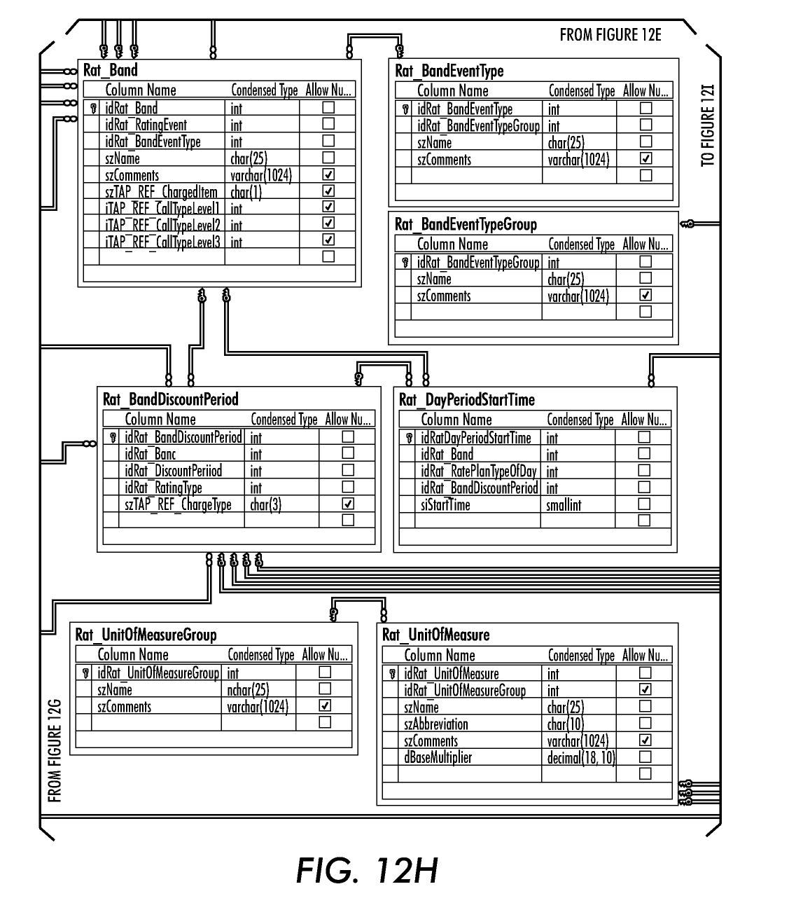

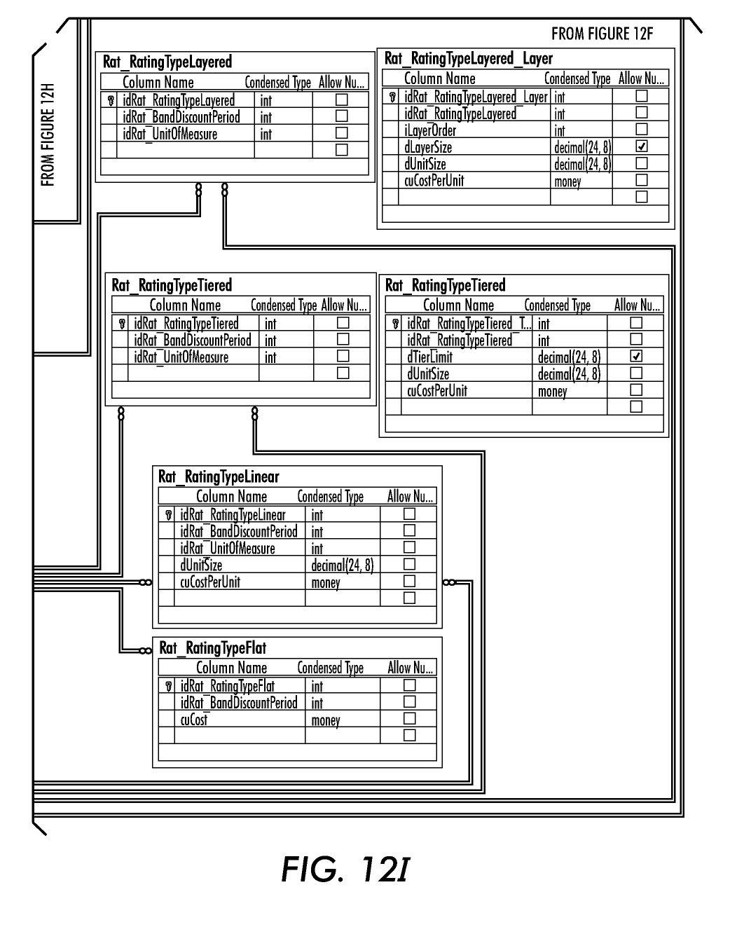

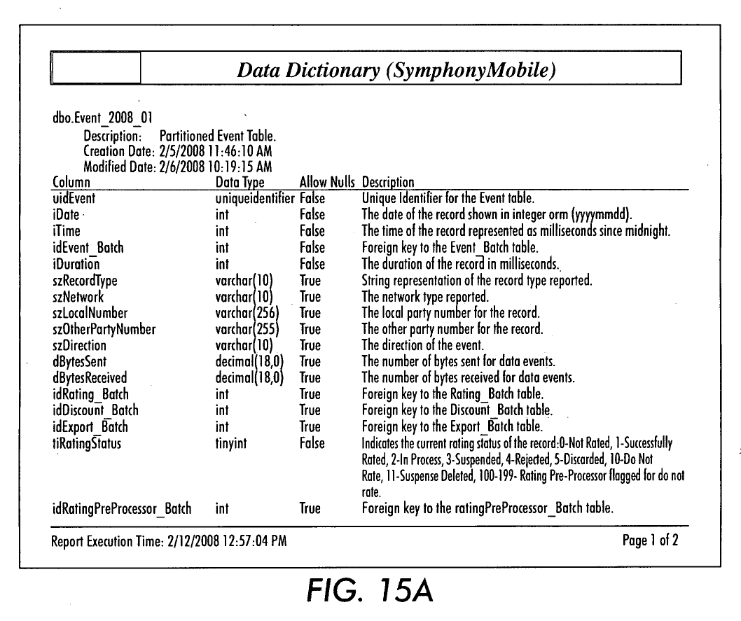

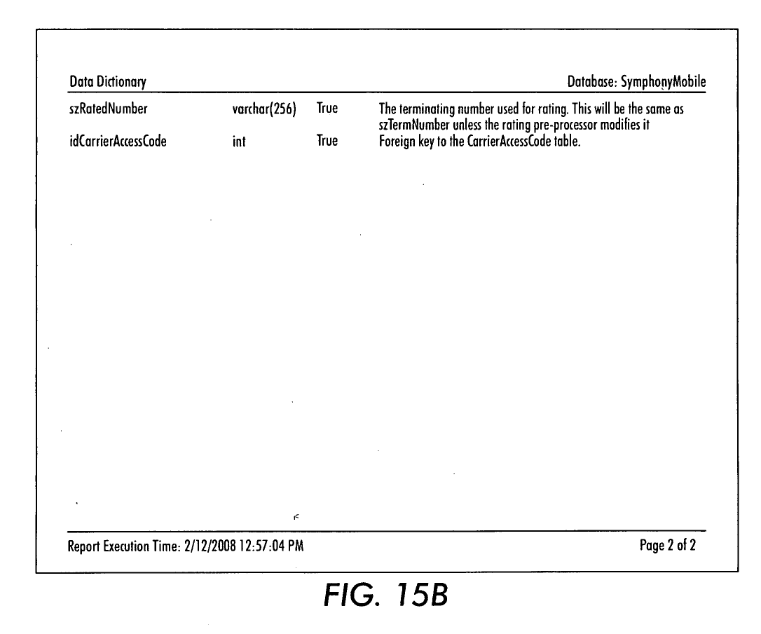

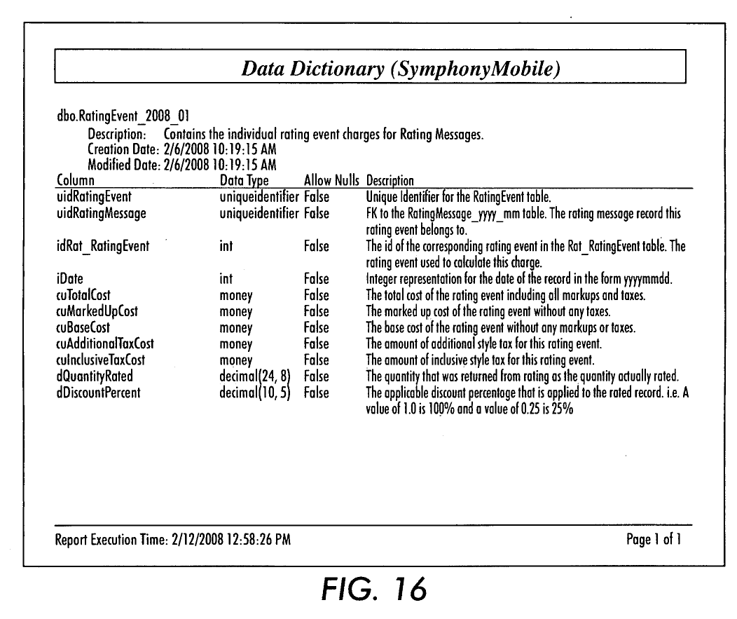

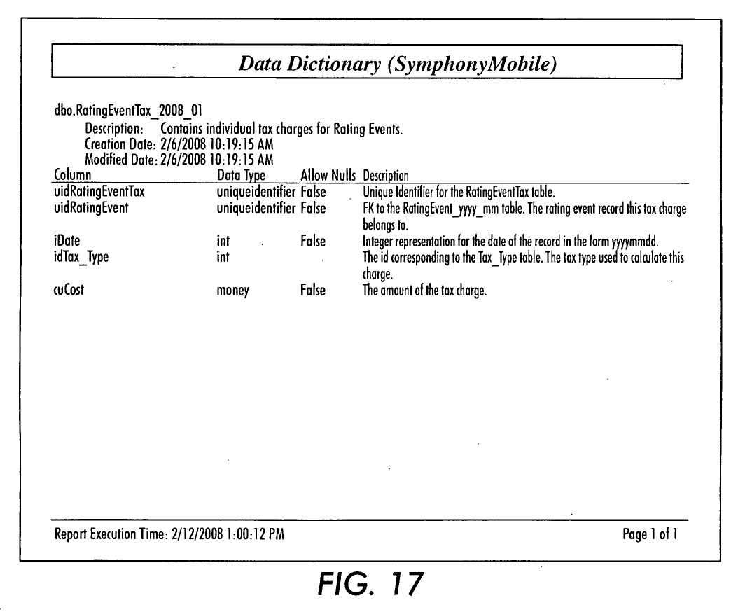

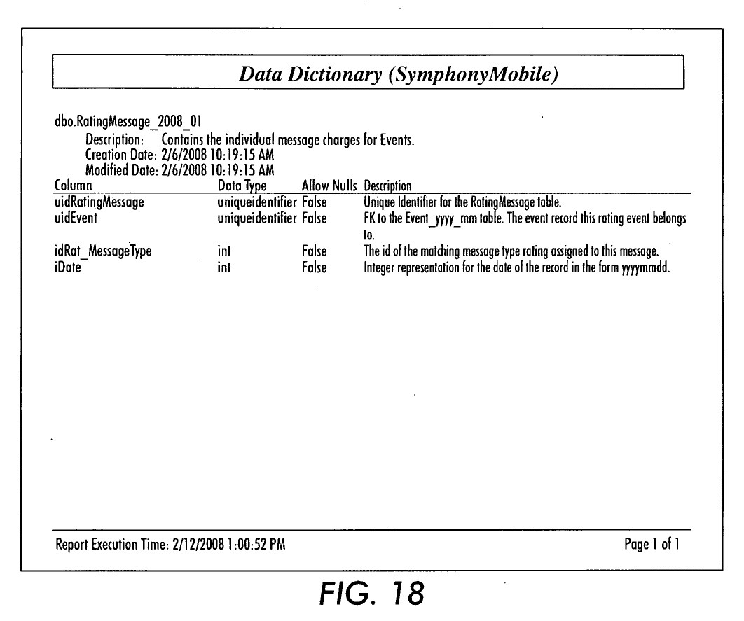

As depicted by the flowchart of FIGS. 11A-G, Rating Client 132, in conjunction with rating server 134, monitors the database 140 for new entries and passes them onto the rating server for rating. Rating or pricing, as used herein, generally includes the following operations or steps:
filtering or data normalization, wherein the call record data is processed to place it in a usable format;
records are then rated, by identifying the related service plan and applying current effective rates and associated taxes using information stored in the rating database depicted in FIGS. 12A-I;
error event reprocessing (see FIGS. 11A-G) is also contemplated for records that cannot be rated.
   Tables for RatingMessage_{—}2008_{—}01, RatingEvent_{—}2008_{—}01 and RatingEventTax_{—}2008_{—}01, as seen in FIG. 14, are then updated with the rated call information (i.e., the data is transformed through a combination of the call detail with the rating). Further definition of the data characterized in the tables of FIG. 14 can be found in the respective data dictionaries illustrated in FIGS. 15A-18. The rating client 132 and rating server 134 combination allows a user to review and test new rates, just entered into the system. The web-based application provides a customer-facing interface, used by an organization's personnel responsible for managing pricing schemes, rates, setting up new service plans and packages to ultimately assign them to the point of service. As used herein, the point of service is a generic term, identifying the entity generating usage, such as telephone number, IP Address, etc. The point of service is assigned to the account, which is billed for the usage generated by the service point.

Next, considering the Post Processor 370, this process takes all activity from the database 140, formats it in a user-specified format, and sends it to a third party application or to the Symphony CRM. Examples of the third party applications that may employ such data include telemanagement software, such as VeraSmart by VeraMark Technologies and comparable software available from Paetec Software, Veramark Technologies, MTS and Acecorn, etc. In use with the Symphony CRM, the system may provide cost allocation and management review/notifications. As noted above, Symphony™ is a state of the art rules based software application and development platform available from Xelex Technologies, Inc. Symphony provides management tools and systems integration capabilities as well as an architecture that allows new products, services and applications to be implemented quickly without sacrifice of the existing business investment. In other words, Symphony is easily configured for many different applications such as mediation, settlements, roaming billing, pre/post pay integration, and rating as are known in the telecommunications industry. The entire process is data driven and can easily be modified by simply editing rules and/or configuration data. Most importantly, the modular design of Symphony allows it to be easily integrated with any existing back office system(s).

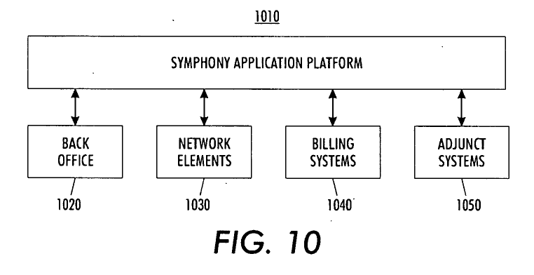

In one embodiment, Symphony is an application platform as depicted in FIG. 10, and comprises a database layer, a business rules layer (with external rules definition) and a presentation layer. The business rules and presentation layers provide connectivity as well as an interface for defining the business rules. The platform 1010 also includes interfaces to back office functionality (1020), network elements (1030), billing systems (1040) and adjunct systems (1050). Symphony components include a template manager for data definitions and file structures, a solution manager as a user interface for defining business rules and system interfaces, and an application manager for compiling and executing the business rules.

The solutions Symphony does or could enable include: CRM—Including Work flow engine; Centrex Collection; Settlements; Real-Time Rating; In-collect/Out-collect Processing; Credit Watch; Usage Archival System; Internet Bill Presentment; State of the Art Mediation (FE Processing); Prepaid/Postpaid Integration; Revenue Assurance; and CC&B Service Bureau. With respect to real-time rating, Symphony's functionality includes:
Scalability—Cost effectively manage growing mediation needs.
Convergence—Safely and effectively bring together data from various systems and network elements.
Modularity—Protects CC&B system from changes in network technology. Allows for the rapid implementation of new service offerings without changing or upgrading a current CC&B system.
Flexibility—Ability to interface with virtually any device capable of delivering usage-based information.
Extendibility—Scalable architecture that enables it to run across multiple processors/machines.
   In summary, Symphony is a carrier-grade, stand-alone “rules based” application platform that enables service providers to launch applications and service offerings within existing open source software (OSS). The embodiments described herein, however, are not limited to use with Symphony, but may employ other systems/software for cost allocation and management.

Continuing with FIG. 3, the post processor 370 provides the following functions: export/import with 3^{rd} party databases, creation of flat or other file output, or other data transfer functionality that will be appreciated by those skilled in the art.

The rating engine or server 130 (also see FIG. 1) computes the charges for any transaction whether it is voice, data, Internet, multi-media, etc. in both real-time and batch-modes while at the same time managing multiple, disparate transaction data streams seamlessly. For example, Voice, Data (IP and Wireless), Multi-Media, utilities and finance transactions can be effectively converged and simultaneously processed with no sacrifice of control.

Another feature that may be implemented in the rating engine/server in accordance with the disclosed system is tracking and control of phone/device usage where costing information, as well as numbers called, may be used to control use of the phone for non-business purposes. For example, the over-the-air provisioning or programming capability may be used to deactivate a phone, permanently or temporarily in the event usage exceeds a predefined limit (e.g., personal usage exceeds 60 minutes/week). In one embodiment described as “credit watch,” the device may be deactivated if the system determines that the user has exceeded a threshold dollar value for a usage category such as overall usage, personal usage, usage by a group/department (e.g., family plan), etc. It is also possible that a fixed value is allocated across multiple phones/devices.

Another example in which over-the-air commands may be used is the control of a business' mobile phone or device via provisioning server 328 (and web interface 210). Using the provisioning server the phone/device may be controlled so that it is not available, except in an emergency, for use by an employee during non-business hours. Or the device is available only during those times when an employee is at work or on-call. As will be appreciated, the ability to activate/deactivate all or some of the services/features available on a phone/device via a web-based or automated interface enables greater control and customization of the phone/device features.

The Rating Engine 130 is designed using efficient methods of remote processing. The server/client technology is implemented over the Internet or intranet. Depending on the number of subscribers of the service provider and the volume of usage which needs to be rated, the Symphony rating server(s) and client(s) can be distributed on separate machines or platforms to balance the load of the data. Traditional rating engines employ data files on the input side and produce rated output files, which are used for billing by the downstream billing system. In a proposed embodiment, the product does not depend on files, but rather responds to individual requests where each request is a single event or a batch of events. This functionality plays a key role in improving speed of performance where it can rate thousands of events per second.

Referring to the screen shot of FIG. 4, depicted in the image is data obtained from database 140 and presented in a web-based interface screen 410. Each line in the display screen provides information about a logged activity. For example the third line represents an outgoing mobile voice call initiated on Feb. 6, 2008 at about 10:45 am. The duration of the call was approximately 11 seconds and the cost was $0.10. The call was on the home (vs. roaming) network and was placed to 585-419-7040. It will also be appreciated that the interface of screen 410 may be adapted to provide information for several devices concurrently as well as permitting control of the particular time periods for which activity is being displayed. Screen 410 may also be employed to characterize the location of the user at the time used if this information is included as part of the call detail record information sent from the device. It will be appreciated additional or alternative information (e.g., quality of service) may also be depicted in the activity monitor based upon what is available in the call detail record.

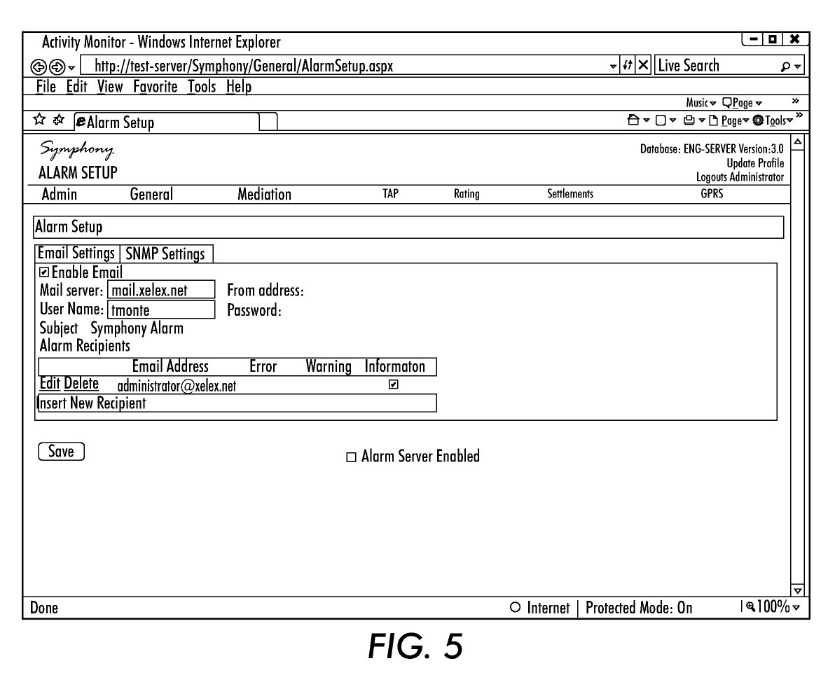

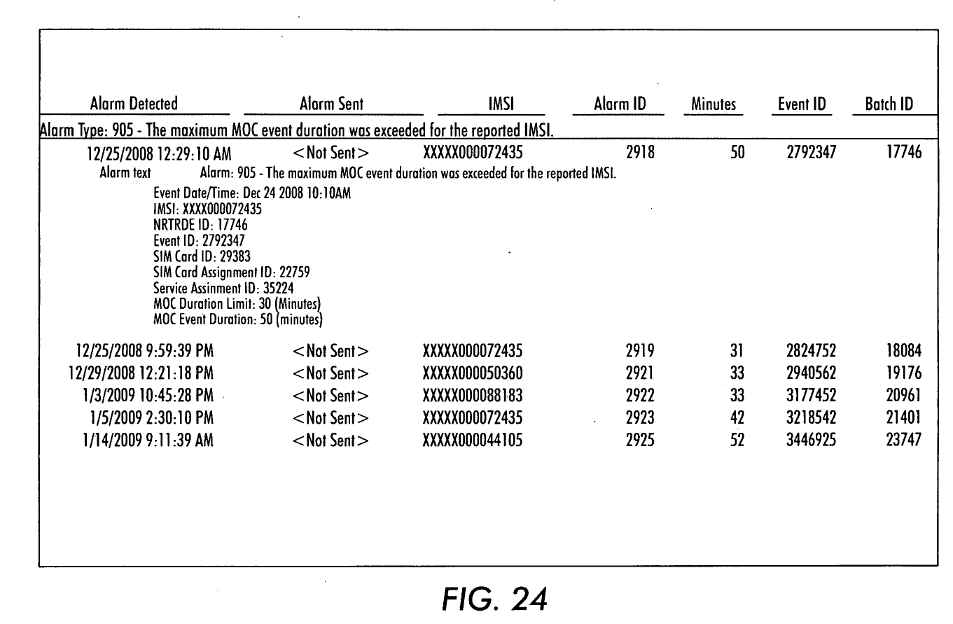

All the servers which are part of the MobileTrack “network” of applications preferably interface with each other and generate alarms in various forms to notify a specified receiver of the message about a problem. The alarm generation criteria can be tailored toward customers' specific requirements, but there are situations which may be supported by Symphony's alarm mechanism as a part of the core product. For example, if a Symphony solution cannot connect to the database 140, it will generate an alarm; or if a mobile collector 120 cannot connect to the phone 110, it will also generate an alarm. Alarm notifications can be sent as an e-mail, or SMS to someone's phone or simply as a report. Moreover, multiple users may be set to receive particular alarms and the alarms may be sent to alternate or additional users (devices) as they escalate in “severity” or based upon the particular nature of the alarm. For example, an e-mail message may be sent at a first (low) level of severity whereas several SMS messages may be initiated at a second (higher) level of severity. The manner in which the alarm is to be sent is, as depicted in FIG. 5, controlled by the alarm interface. In the example, the user indicated receives an e-mail in response to an alarm. One example of an alarm interface is depicted in FIG. 24, wherein the type of alarm is indicated in a hierarchical structure. More specifically, the interface screen indicates the alarm data/time in the leftmost column, followed by information as to the alarm sent. The middle column reflects the International Mobile Subscriber Identity (IMSI) information. In the alarm ID, a separate and unique identifier is assigned for each alarm. The Event ID and Batch ID reflect identifying fields of the record in the database. In the example, the “MOC” illustrates an alarm for a mobile originated call.

To facilitate the alarm functionality a customer will appoint personnel in their organization who will be responsible for monitoring alarms and react to them according to the severity of the problem. MobileTrack's web application provides a dialog where the system administrator sets up the contact information of the recipient of the generated alarm.

Event Table Layout
Description: Partitioned Event table.
Creation Date: Feb. 5, 2008 11:44:27 AM
Modified Date: Feb. 5, 2008 11:44:27 AM

| | | Allow | |
|---|---|---|---|
| Column | Data Type | Nulls | Description |
| uidEvent | uniqueidentifier | False | Unique identifier for the Event table. |
| iDate | int | False | The date of the record shown in integer form |
| | | | (yyyymmdd). |
| iTime | int | False | The time of the record represented as |
| | | | milliseconds since midnight. |
| idEvent_Batch | int | False | Foreign key to the Event_Batch table. |
| iDuration | int | False | The duration of the record in milliseconds. |
| szRecordType | varchar(10) | True | String representation of the record type |
| | | | reported. |
| szNetwork | varchar(10) | True | The network type reported. |
| szLocalNumber | varchar(256) | True | The local party number for the record. |
| szOtherPartyNumber | varchar(256) | True | The other party number for the record. |
| szDirection | varchar(10) | True | The direction of the event. |
| dBytesSent | decimal(18, 0) | True | The number of bytes sent for data events. |
| dBytesReceived | decimal(18, 0) | True | The number of bytes received for data events. |
| idRating_Batch | int | True | Foreign key to the Rating_Batch table. |
| idDiscount_Batch | int | True | Foreign key to the Discount_Batch table. |
| idExport_Batch | int | True | Foreign key to the Export_Batch table. |
| tiRatingStatus | tinyint | False | Indicates the current rating status of the |
| | | | record: 0 - Not Rated, 1 - Successfully Rated, |
| | | | 2 - In Process, 3 - Suspended, 4 - Rejected, |
| | | | 5 - Discarded, 10 - Do Not Rate, 11 - Suspense |
| | | | Deleted, 100-199 - Rating Pre-Processor |
| | | | flagged for do not rate. |
| idRatingPreProcessor_Batch | int | True | Foreign key to the RatingPreProcessor_Batch |
| | | | table. |
| szRatedNumber | varchar(256) | True | The terminating number used for rating. This |
| | | | will be the same as szTermNumber unless the |
| | | | rating pre-processor modifies it |
| idCarrierAccessCode | int | True | Foreign key to the CarrierAccessCode table. |

Each Activity Record is entered into this table and based on the rating status the record will be rated and/or just sent to the third party feed.

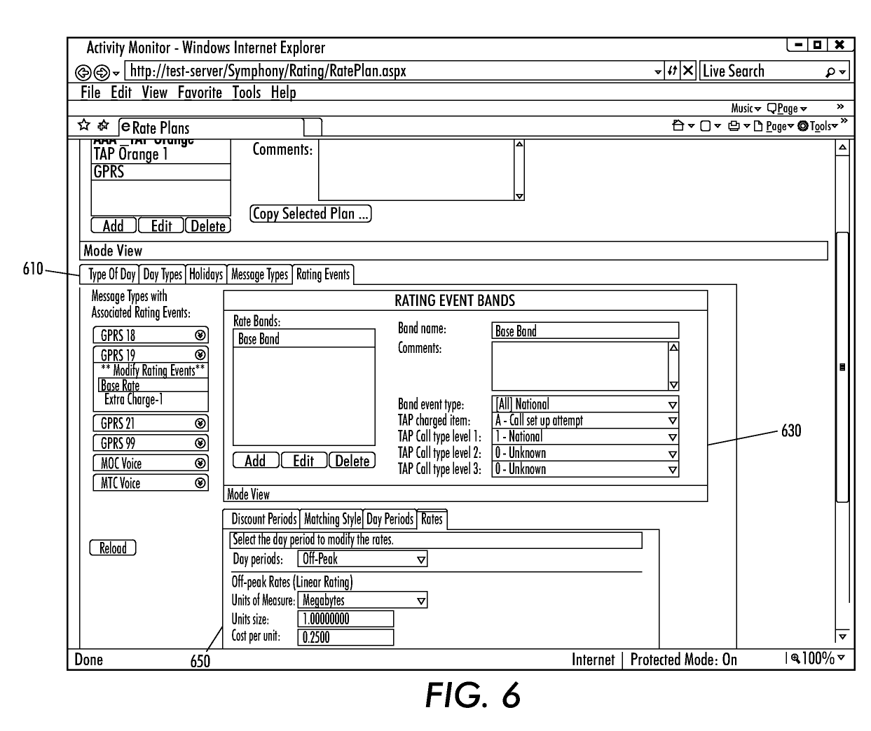

Having described the alarm function, attention is turned next to FIG. 6, where there is shown a web-based user interface for the rating engine. In particular, the interface illustrates an example screen for setting up one portion of the rate structure. As intended, the rating event data is entered by an administrator of the system, or it could optionally be imported from another source. For each of the rating types (e.g., GPRS), the user interface includes a plurality of tabs 610 that allow for selection of the associated type of rate breakdown, including for example, type of day (weekend, weekday), message type and rating events. As used herein, the Day Types tab may be employed to control, in different regions/cultures, those days that are set aside as weekends versus weekdays. In the Rating Events tab, the various rating bands are defined via the fields in region 630, and in response to completion and saving of the rate plan information (see e.g., RatePlan.aspx).

The interface of FIG. 6 also provides, in region 650, the ability for the administrator to enter information relative to rates, discounts, etc. As more specifically illustrated in the flowchart of FIGS. 11A-G, the information entered into the rating event interface is stored in the rating database (e.g., FIGS. 12A-I) and used by the rating engine/server to provide rating information based upon received usage data. Once the rating database of FIGS. 12A-I has been populated with the required rate data, the rating engine is able to use the rate information to provide real-time rate data for use by the mobile collector as noted above.

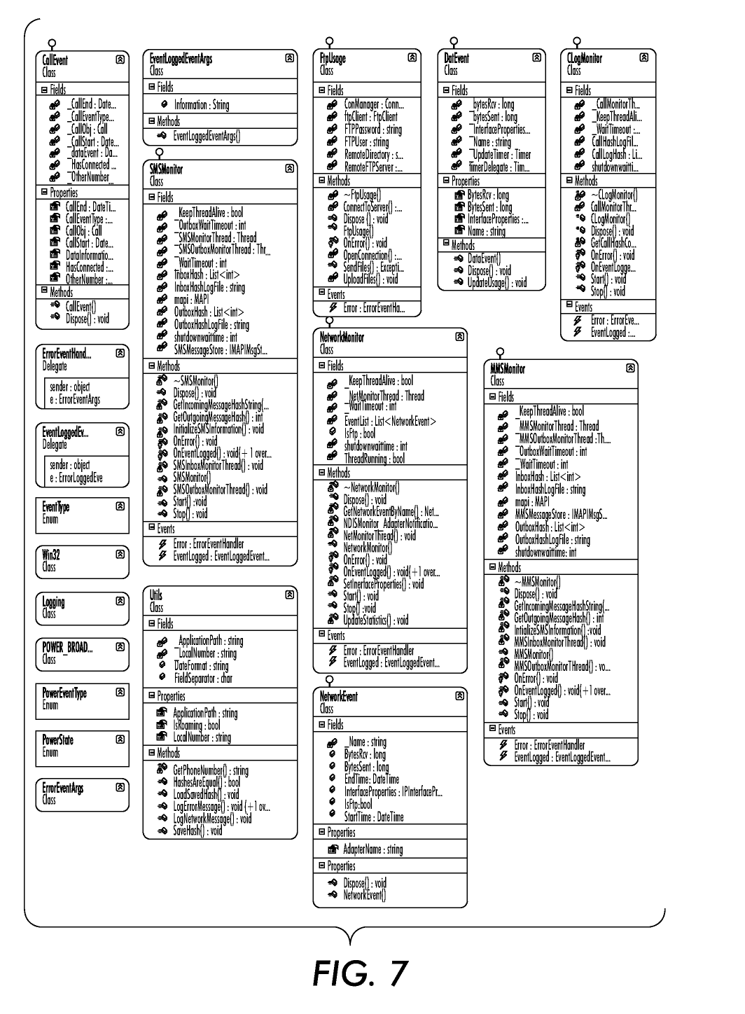

As previously noted, FIGS. 7-9 are exemplary representations of the software organization for an embodiment of the system depicting the software components that reside on the phone or device 110, and they depict various classes and software components used in an embodiment of the system. Source code that provides the functionality is found, for example in the DeviceAppCode.txt file in the Appendix. In FIG. 7, an overview is depicted of the class (module) structure of one of the libraries that would run on the mobile device. For example, the phone or device 110, would have one or more processes or monitors operating, where the occurrence of an event would be detected and logged to create a call detail record.

Considering the SMS monitor 710, for example, the monitor would, upon detecting an incoming SMS message initiate the collection and storage of data associated with the message event as represented by method SMSMonitor.cs code.

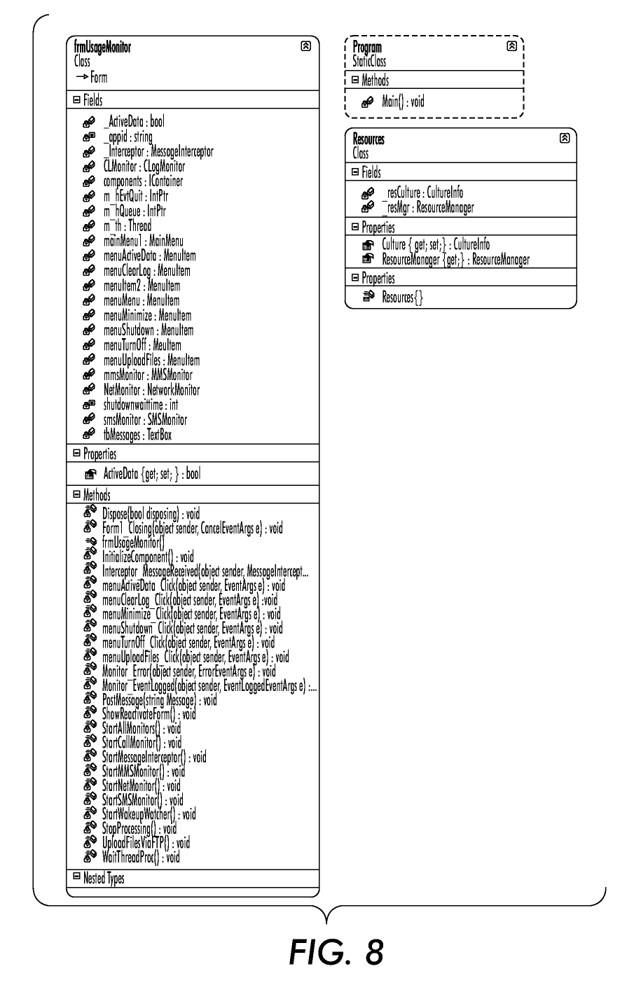

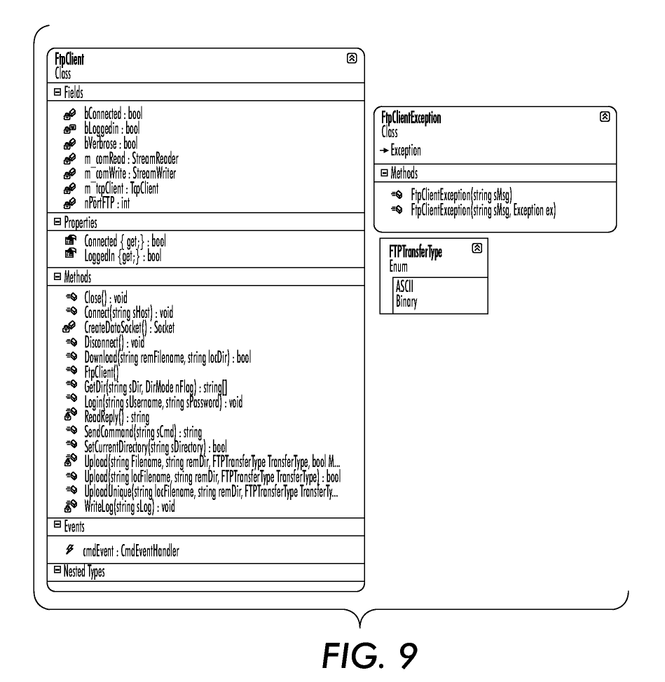

Like FIG. 7, FIGS. 8 and 9 also depict information pertaining to the code operating in the mobile devices such as Windows-based devices. As will be appreciated other types of devices may be supported by the system and may require modification of the disclosed code in order to enable similar functionality on such devices. FIG. 8 is a representation of the application code, whereas FIG. 9 represents the FTP client code used to send data to an FTP server. More specifically, FIG. 8 illustrates the main or application program that includes the UsageMonitor (formUsageMonitor.cs in DeviceAppCode.txt). Here again this application resides on the phone 110, which initiates a plurality of monitoring processes (smsMonitor, mmsMonitor, NetMonitor, for SMS, MMS and network access events, respectively). Similarly, the CLogMonitor process is initiated to identify call events and to generate the call detail record and populate the record with data indicative of the event(s). Once the event is logged, and assuming a communication channel is available, the call or event detail record is then sent to the mobile collector.

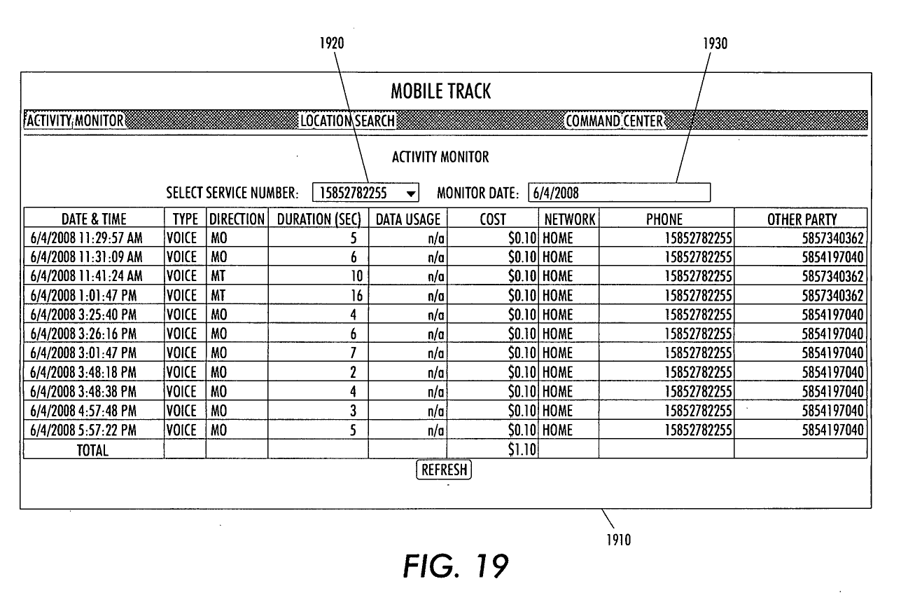

As noted previously relative to FIG. 1, after each event is completed phone 110 transmits activity data such as the call detail record, or a similar data schema, to the mobile collector 120. Referring to FIG. 19, depicted therein is a user interface screen that may be displayed by the MobileTrack™ system. Interface screen 1910 is typically disclosed in a window on a convention computer workstation. MobileTrack provides an activity monitor function as shown in the interface, wherein a plurality of communications events may be displayed for a selected service (phone) number. Although a number of characteristics for the activities can be displayed, those depicted in the activity log of FIG. 19 include: Date & Time; Type (voice, text, web, etc.), Direction, Duration, Data-Usage (KB), Cost (based upon rating data applied from rating server), Network, Phone (number of device), Other Party (number of other party in transaction).

The activity monitor interface depicted in FIG. 19 may be used to review information for other phones, and it is possible to add devices by entering the number for the device in field 1920. It should be appreciated that field 1920 may be populated via a pull-down menu, with auto-fill, etc. Similarly, the date range(s) to be viewed may be selected by entering the desired date or range into field 1930. It will be further appreciated that the date(s) or range may be selected by a link to a calendar or similar well-known interface for date selection.

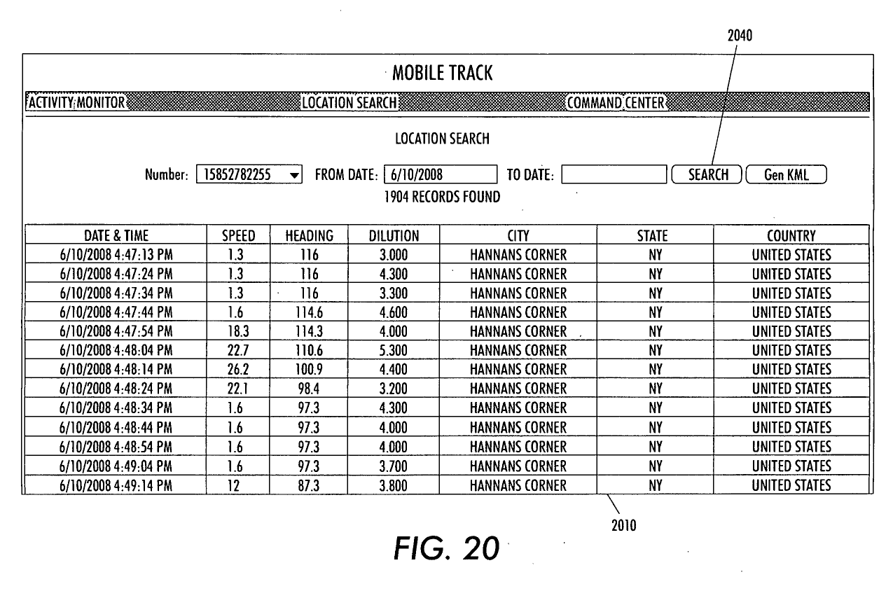

Referring to the user interface screen 2010 depicted in FIG. 20, another MobileTrack feature is illustrated. In the Location Search window 2010, the fields at the top of the webpage-like interface are again used to select the phone/device (by phone number), as well as the range of dates for data to be presented. Once the desired characteristics are entered, and the user selects search button 2040, the list of call data records (CDRs) meeting the search characteristics are displayed in the bottom of the window. As with the example of FIG. 19, the information depicted for each of the search results may be specified by a user via a set of preferences or a interface selection (not shown). Each item in the list not only reflects information pertaining to the call, message, etc., it also indicates the last-known or last-good location of the phone/device. The information is provided by the device via GPS, triangulation based on communication tower signals, coordinates and/or in the manner disclosed in U.S. Pat. No. 7,397,424 to Houri, which is hereby incorporated by reference in its entirety. The device sends the coordinates, speed, heading, dilution (signal strength), etc. Such information is used by the MobileTrack system to further determine the information provided in the remainder of the listing.

For example, the GPS coordinates are used to identify the city, state/province and country data depicted in the rightmost three columns of the Location Search data. In one embodiment, the GPS coordinates may be input to a programmed device that provides, in response to the coordinates, the indicated location details. In one embodiment, publicly available zip code and GPS data was used to establish a central coordinate for each zip code zone. The MobileTrack system then uses the device's GPS coordinate and mathematically determines which, if any zip code locations are within a series of circles having increasing radii. When one or more of the zip coordinates are determined to be within the circle, the location is selected, if only one, or if multiple zip coordinates are determined to be within a circle, then actual distances may be calculated to determine the closest zip coordinate, and the city and state determined therefrom. It will be appreciated that alternative methods may be employed to obtain such data, including proprietary databases of GPS coordinates, etc.

As briefly mentioned above, the CDR sent from a phone may not only provide the last-known GPS location associated with a call, but it may also include a plurality of locations that have recently been acquired by the GPS-capable phone. For example, based upon programmed controls, the device may collect GPS coordinates on a regular periodic basis and/or in response to the speed information (e.g., more frequent GPS coordinate sampling as the speed increases). The GPS coordinate data received from the device may be stored in the system database. As indicated by button 2050, a MobileTrack user may generate a GPS location output in the form of a Keyhole Markup Language (KML) file, an XML-based language schema for expressing geographic locations to facilitate annotation and visualization on existing graphical representations such as maps. Moreover, the file may be input into Google-Maps or similar programs that enable the path/route of the device, over time, to be depicted.

In a related embodiment, the disclosed system and method, incorporating location data into that exchanged with the server permits the server to responsively provide information to the user of the client device. Various organizations such as utilities, water/sewer authorities, departments of transportation, railroads, etc. would use the system, based upon location, to obtain GIS maps and drawings for the location of installation/facilities downloaded to personal devices/phones. One such application contemplated is the linking of the server with a GIS or similar mapping or logistical data source so that in response to the personal communication device's location data, the server sends back to the user a map or other facility information to assist a service worker. More specifically, the system may be employed by a utility or municipality and when a worker arrives at a site requesting service/repair, the worker's communication device, in response to the GPS or similar location data, receives from the server a map or similar representation of the location of key components (power lines, water mains, shutoffs/valves, phone lines, building access points, etc.), equipment (e.g., pumps, street lights, traffic lights, etc.) and the like. Such an application would reduce or eliminate the need for service personnel to travel to a central location in order to obtain drawings between service calls. Also contemplated is the use of location information to coordinate meter reading and similar periodic delivery, inspection and other operations.

Another application contemplated in accordance with the features enabled by the disclosed system is the use of provisioning to control the availability of certain device features dynamically. The FamilyTrack™ embodiment could include the ability to enable or disable certain features of the client device based upon location information. For example, parents may be able to control the device so as to disable personal text messaging features whenever the device is within a certain geographic location (e.g., school grounds), or if the device's position information indicates that the device is located in a vehicle (e.g., distance traveled is calculated between most recent position updates and divided by time to determine an average speed, and if the average speed is above a threshold). If the device is determined to be in a vehicle, messaging functionality may be turned off temporarily until the device is determined to be at rest or not travelling at a vehicle's speed. It will be appreciated that while the server would likely control, through provisioning, the features based upon location, it is conceivable that the device itself may have a software application installed via the provisioning tools that locally enables/disables features based upon detected position information.

Other features of a FamilyTrack application may include text monitoring and all other MobileTrack capabilities and features as they could be applied to a group of phones and/or devices. In the FamilyTrack embodiment, the “administration” of the devices could be done through a web-based interface that is accessible on the server, providing a user having administrative privileges (e.g., a parent) with the ability to control various features of the device as well as to process and review usage data.

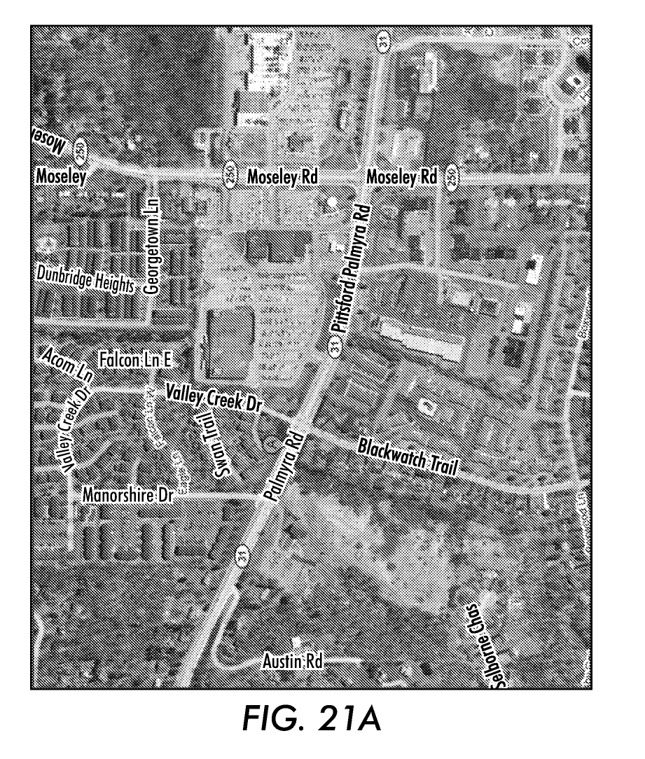

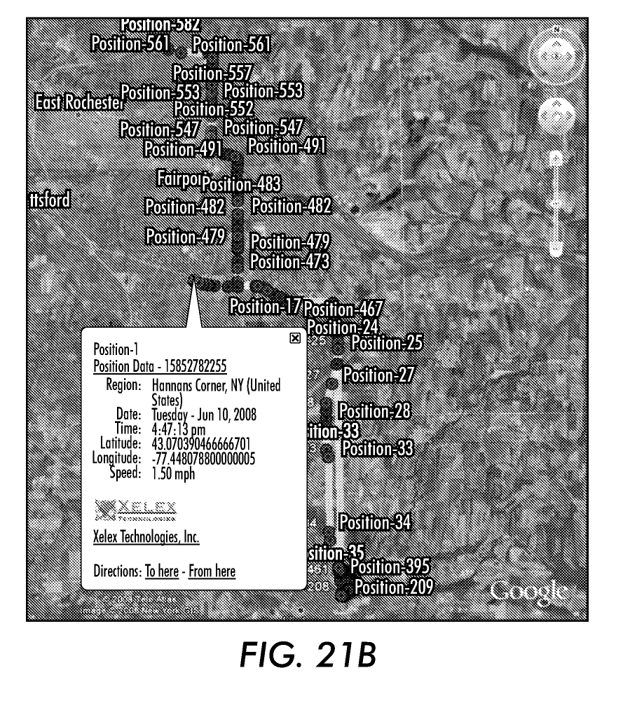

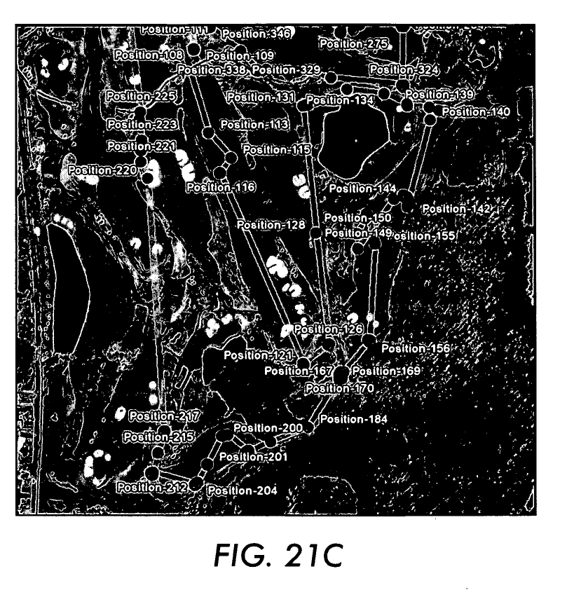

Referring briefly to FIG. 21A, shown is a map presentation where the last-known location of the phone/device is illustrated (see ref. A). It will be appreciated that the presentation of the map or similar display may also have traditional capabilities for zooming, panning, etc. FIG. 21B is an illustration of a plurality of GPS coordinates from a phone, plotted as a result of the data being uploaded to the MobileTrack database via a call data record or similar transmission. The plot shows each of a series of GPS locations sampled by the device, temporarily stored in the phone and then transmitted to the MobileTrack database. Similarly, FIG. 21C shows a plot of locations based upon a user carrying the phone during a round of golf.

As noted previously, the GPS coordinate data may include headings and speed (knots). Such information may provide for the sharing or exchange of additional information of interest or as requested by the user of the device. One embodiment contemplated, as noted previously, is a weather update/warning system, whereby the user receives information based upon current (most recent) location and heading.

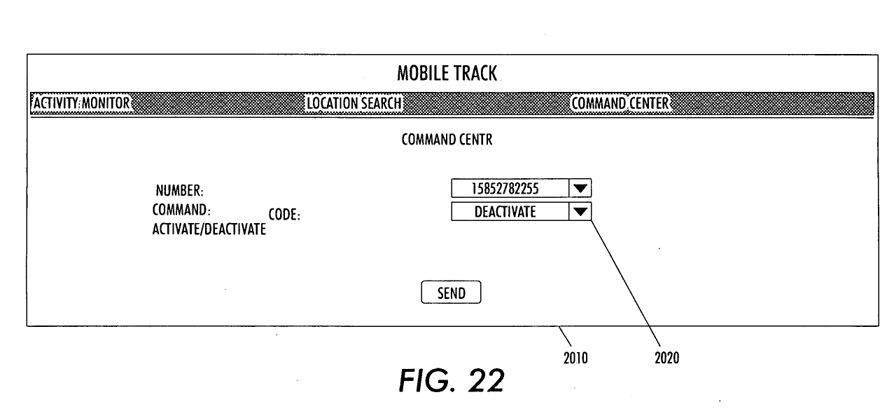

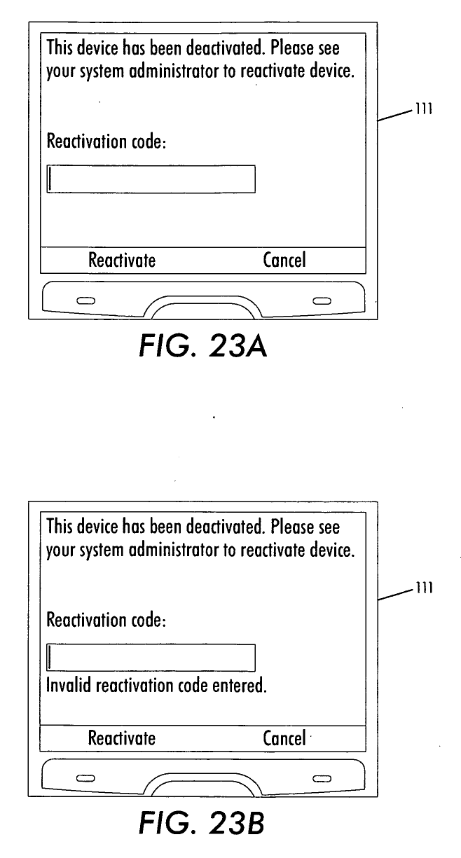

Turning next to FIG. 22, disclosed therein is an interface window 2210 that represents aspects of the command center functionality provided in MobileTrack. The command center is able to provide a number of functions/features via over-the-air provisioning or programming. In one embodiment, the MobileTrack administrator may control the phone/device. For example, as depicted in FIG. 22, MobileTrack may deactivate the functionality of the phone/device. Upon doing so, by selecting the “SEND” button in FIG. 22, a provisioning control message is sent to the phone and the device is deactivated. FIG. 23A illustrates the resulting display on a screen 111 of device 110 (FIG. 1). In order to re-activate the device, the MobileTrack administrator must authorize the re-activation or a pre-assigned password must be input by the phone/device user. FIG. 23B depicts another screen 111 that shows a screen presented on the device if a user of the device tries to input a password that is not accepted.

Referring again to FIG. 22, the commands in field 2020 may be selected from a pull-down menu. Examples of such commands are activate/deactivate, backup data, backup contacts, “where am I” (last known GPS location), etc. The activate/deactivate commands have been described. The backup data command prompts the phone/device to send data stored thereon (e.g. calendar, contacts, user-entered information, e-mail and messages, etc.) to the server for storage and possible copying to another device. Similarly, the backup contacts command prompts the phone/device to send contact data stored thereon (e.g. contact list) to a server or other devices for storage and possible copying to another device. As noted above, this information may also be sent in response to a heartbeat transmission. Upon selecting the command and then the SEND button, the command is sent to the phone/device where the command is executed. Other commands that may be included are commands that may limit the functionality of the phone/device, permitting limited calling capability, disabling device usage during non-business hours, limiting text or other messaging, preventing roaming or international usage, etc.

As noted above, a software development environment that may be used for the programmatic code executed by the various processes and devices described herein is the Symphony system as described above, and developed and marketed by Xelex Technologies, Inc., which may include libraries and related code from one or more companies such as Mobile In The Hand by In-The-Hand, Ltd. and OpenNETCF Consulting, LLC.

In yet another embodiment, the devices may further include resistive touchscreens. Phones and other mobile devices may make use of Synaptic's technology that enables users to perform gestures that the phone can recognize as different commands: single-finger tap, double tap, tap and hold or tap and slide, press, flick and two-finger pinch and more. Such information, including other possible gesturing or responsiveness may be tracked and further reported using the technology disclosed herein. For example, characteristics about a user's interaction, such as applied pressure (e.g., aggressiveness), intervals (e.g., speed of reading/browsing), as well as others, may provide insights into the user's interaction, preferences, etc.

It will be appreciated that various of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A system for tracking usage of a user's mobile communication device, comprising:
a programmable processor operatively associated with the user's communication device, said processor operating to collect data associated with the user's usage of the communication device;
a device memory for storing usage data associated with the user's usage activity, said processor storing said usage data in the device memory;
a network for sending the stored usage data to a computer operating as a mobile collector, said mobile collector receiving the usage data from a plurality of mobile communication devices; and
a corporate server for receiving processed usage data from said mobile collector and transforming the processed usage data by associating said usage data with one of a plurality of accounts.

2. The system according to claim 1, further including a rating server, wherein said rating server receives events in real time and produces cost data for each event based upon usage data, and communicating the cost data back to the mobile collector for further processing, wherein said mobile collector further transforms the processed usage data by including the cost data therein.

3. The system according to claim 2, wherein said mobile collector, operating based upon client information in said usage data, associates the usage data with client accounts.

4. The system according to claim 2, wherein said mobile collector, operating based upon telephone number information in said usage data, allocates the usage data into business and personal categories, and outputs reports indicating usage relative to the business and personal categories.

5. The system according to claim 1, wherein said mobile collector, operating based upon usage data including location information, tracks the location of the communication device.

6. The system according to claim 1, further including a provisioning server, operating to initiate a provisioning exchange with said communication device.

7. The system according to claim 6, wherein the provisioning exchange causes the deactivation of the communication device.

8. The system according to claim 7, wherein the provisioning exchange initiated by the provisioning server causes the activation of a deactivated communication device.

9. The system according to claim 6, wherein the provisioning exchange includes exchange of data with the communication device.

10. The system according to claim 9, wherein the exchange of data is a software update transmitted from the provisioning server to the communication device, and stored by the communication device for installation.

11. The system according to claim 10, wherein the exchange of data is a data transmitted from to the provisioning server from the communication device, and the data is stored in memory by the provisioning server.

12. The system according to claim 6, wherein the provisioning exchange causes the communication device to send, to the corporate server, location data.

13. The system of claim 2, further including a rating client and wherein said rating client in combination with said rating allows a user to review and test new rates entered into the system.

14. The system of claim 1, wherein said device memory stores location data associated with the device, and where said corporate server receives and stores said location data.

15. A method for tracking the usage of a mobile communication device, comprising:
in response to usage of the device, collecting data associated with such usage;
creating a usage data record associated with such activity and storing the record in memory;
sending the usage data record to a mobile collector, said mobile collector receiving, storing and processing records from a plurality of such mobile communication devices; and
sending processed usage data from said mobile collector, and associating said usage data with one or more accounts, to a server for subsequent integration with at least one other application.

16. The method according to claim 15, further including receiving events in real time on a rating server, said rating server producing cost data for each event and communicating the cost data back to the mobile collector for further processing, wherein said mobile collector includes the cost data in the processed usage data.

17. The method according to claim 15, further including controlling operation of the device through a provisioning interface, wherein the device may be deactivated or activated in response to a selection on a remote user interface.

18. The method according to claim 15 wherein the application includes a call accounting and usage monitoring system to monitor use of at least one device.

19. The method according to claim 18, further including controlling operation of the device through a provisioning interface, where the device may be deactivated or activated remotely, wherein said device is deactivated in the event usage exceeds a predefined limit.

20. The method according to claim 18, further including controlling operation of the device through a provisioning interface, where the device may be deactivated or activated remotely, wherein said device is deactivated when the system determines that a user has exceeded a threshold dollar value for a usage category.

21. The method according to claim 18, wherein a provisioning service is used to remotely limit the time period during which the device is activated.

22. The method according to claim 18, wherein a provisioning service is used to remotely control the time period during which at least one feature of the device is activated.

23. The method according to claim 21, wherein said provisioning service, in conjunction with said call accounting and usage monitoring system, is operated in accordance with a user-defined schedule.

24. The method according to claim 15 wherein data includes location information and where the at least one other application processes the location information collected with usage data and provides the location information in a viewable format.

25. The method according to claim 24, wherein the viewable format includes data points illustrated graphically on a map.

26. The method according to claim 24, wherein the viewable format includes an indication of at least the nearest municipality.

27. The method according to claim 24, wherein the device collects location coordinates on a periodic basis and sends such information to the mobile collector.

28. The method according to claim 24, wherein the device collects location coordinates on a periodic basis, the period of which is a function of a speed determined from the location coordinates.

29. The method according to claim 15, wherein said mobile collector, upon receiving a usage record, identifies the usage record as a mobile originating call, validates the data in the record, and inserts the record into the event tables of a database.

30. The method according to claim 29, wherein the event tables in the database are subsequently accessed and information therein further processed to create a report.

31. The method according to claim 30, wherein the further processing of the data in the event tables includes filtering to place the data in a usable format.

32. The method according to claim 30, wherein the process further includes rating the usage records, by identifying the related service plan and applying current effective rates and associated taxes based upon information stored in a rating database.

33. The method according to claim 32, wherein a user tests new rates by entering such information.

34. The method according to claim 15, wherein the device memory stores location data associated with the device, and where the server receives and stores the location data.

35. The method according to claim 34, wherein a provisioning service, associated with the server, is used to remotely control at least one function of the device as a function of the location data.

36. A communication usage and expense tracking system, comprising:
a plurality of mobile communication devices, each including a programmable processor for collecting data associated with usage of the communication device, and device memory for storing a usage record associated with such activity;
communication means for transmitting the usage record(s) from each device to a mobile collector, said mobile collector receiving usage records from the plurality of mobile communication devices; and
a database for receiving and storing usage records and processed usage data from said mobile collector and associating said usage data with one or more accounts.

37. The system according to claim 36, further including a rating server, said rating server processing usage records in real time and producing cost data for each event identified in the usage records, said rating server communicating the cost data back to the mobile collector for further processing, wherein said mobile collector includes the cost data with the processed usage data.
